(19) United States
(12) Patent Application Publication
(10) Pub. No.: US 2026/0070001 A1
(43) Pub. Date: Mar. 12, 2026

(54) COMPOSITION OF CHROMATOGRAPHIC SORBENTS AND METHODS FOR ANALYSIS OF ANTIBODY DRUG CONJUGATES

(71) Applicant: Phenomenex, Inc., Torrance, CA (US)

(72) Inventors: ChengKang MAI, Torrance, CA (US); Ismail RUSTAMOV, Redondo Beach, CA (US); A. Carl SANCHEZ, Los Angeles, CA (US); Cuong Ngoc HOANG, San Gabriel, CA (US); Miklos CZAUN, Los Angeles, CA (US)

(21) Appl. No.: 19/107,566

(22) PCT Filed: Aug. 30, 2023
(86) PCT No.: PCT/US2023/073143

§ 371 Date: Feb. 27, 2025

Related U.S. Application Data
(60) Provisional application No. 63/374,382, filed on Sep. 2, 2022.
(60) Provisional application No. 63/505,876, filed on Jun. 2, 2023.

(51) Int. Cl. B01D 15/30; B01J 20/286; B01J 20/32

(52) U.S. Cl. CPC B01D 15/305; B01J 20/286; B01J 20/3204; B01J 20/3278; B01J 20/3293

(57) ABSTRACT

The present disclosure provides chromatography compositions and methods for separation of biomolecules, in particular, stationary phases and chromatography columns for improved separation and resolution of DAR species in antibody drug conjugates (ADCs). In one example, a method comprises: (a) exposing the sample to a chromatographic stationary phase of a reverse phase chromatography column, and (b) applying an eluent to the chromatography column to elute the DAR species of antibody-drug conjugate in their native state, wherein the chromatographic stationary phase comprises: a solid support; and a polymer coating on a surface of the solid support; wherein the polymer coating comprises a copolymer comprising a first hydrophilic monomer and a second hydrophilic monomer, wherein the first hydrophilic monomer and second hydrophilic monomer have different hydrophilicity, wherein the copolymer has a tuned hydrophilicity determined by a molar ratio of the first hydrophilic monomer to the second hydrophilic monomer.

### CROSS-REFERENCE TO RELATED APPLICATIONS

This application is a Section 371 National Stage Application of International Application No. PCT/US2023/073143, filed on Aug. 30, 2023, entitled “COMPOSITION OF CHROMATOGRAPHIC SORBENTS AND METHODS FOR ANALYSIS OF ANTIBODY DRUG CONJUGATES,” which claims the benefit of and priority to U.S. Provisional Application No. 63/374,382, filed on Sep. 2, 2022, titled “Composition Of Chromatographic Sorbents And Methods For Analysis Of Antibody Drug Conjugates”, and to U.S. Provisional Application No. 63/505,876, filed on Jun. 2, 2023, titled “Composition Of Chromatographic Sorbents And Methods For Analysis Of Antibody Drug Conjugates”, the contents of which are hereby incorporated by reference in their entirety.

### BACKGROUND

Antibody-Drug Conjugates (ADCs) are a class of highly potent biopharmaceutical drugs built by attaching a small molecule therapeutic agent to an antibody, with either a permanent or a labile linker. The antibody targets a specific antigen only found on target cells. Once an ADC binds to the cell, it triggers internalization of the antibody, together with the drug. This delivers drugs with a very high specificity to the diseased cells, maximizing their efficacy and minimizing systemic exposure, with the associated risk of side effects.

Application of ADCs is one of the research and development hotspots in the field of medicine and targeted immunotherapy. More than 100 ADCs are currently in different stages of clinical development, and there are hundreds of ongoing clinical trials. Consequently, there is an increasing demand for innovative solutions for the purification and analysis of ADCs. Chromatography columns have been used for the analysis of ADCs. However, current chromatography columns do not provide sufficient resolution of ADC component species. Improved chromatographic separation columns and methods for the analysis of ADC DAR species are very useful for improving product quality, efficacy and safety.

### SUMMARY

In one aspect, the present disclosure relates to chromatography compositions and methods for separation of biomolecules, in particular, stationary phases and chromatography columns for improved separation and resolution of ADCs using mass spectrometry compatible conditions.

### SELECTED DEFINITIONS

As used herein, “weight percent,” “wt %, “percent by weight,” “% by weight,” and variations thereof refer to the concentration of a substance as the weight of that substance divided by the total weight of the composition and multiplied by 100.

As used herein, “molar percent,” “mol %”, “percent by mol,” and variations thereof refer to the relative content of a substance as the mole of that substance divided by the total mole of the composition and multiplied by 100.

As used herein, “volumetric percent,” “vol %”, “percent by volume,” and variations thereof refer to the relative content of a substance as the mole of that substance divided by the total volume of the composition and multiplied by 100.

As used herein, “g” represents gram; “L” represents liter; “mg” represents “milligram (10-3 gram);” “μg” equals to one microgram (10-6 gram). “mL” or “cc” represents milliliter (10-3 liter). One “μL” equals to one microliter (10-6 liter). The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (° C.).

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

As used herein, references to column “prototype 1”, or prototype column “V1”, refer to the same tested prototype and these designations are used interchangeably. Similarly, “prototype 2” or column “V2”, also refer to the same prototype column and are used interchangeably throughout the disclosure.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention.

Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 1%, 5%, 10%, 15%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 1%, 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5% or even 1%) detectable activity or amount.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

As used herein “antibody drug conjugates: or “ADCs” are biologically active drugs attached to monoclonal antibodies (mAbs) by chemical linkers or linker units with labile bonds.

“Antibody” is used herein in the broadest sense and specifically covers monoclonal antibodies, polyclonal antibodies, multi-specific antibodies (e.g., bispecific antibodies), and antibody fragments. Antibodies may be murine, human, humanized, chimeric, or derived from other species. An antibody is a protein generated by the immune system that is capable of recognizing and binding to a specific antigen. (Janeway, et al (2001) “Immunobiology”, 5th Ed., Garland Publishing, New York). A target antigen generally has numerous binding sites, also called epitopes, recognized by CDRs on multiple antibodies. Each antibody that specifically binds to a different epitope has a different structure. Thus, one antigen may have more than one corresponding antibody. Antibody also refers to a full-length immunoglobulin molecule or an immunologically active portion of a full-length immunoglobulin molecule, i.e., a molecule that contains an antigen binding site that specifically binds an antigen of a target of interest or part thereof, such targets including but not limited to, cancer cell or cells that produce autoimmune antibodies associated with an autoimmune disease. The immunoglobulin disclosed herein can be of any type (e.g., IgG, IgE, IgM, IgD, and IgA), class (e.g., IgG1, IgG2, IgG3, IgG4, IgA1 and IgA2) or subclass of immunoglobulin molecule. The immunoglobulins can be derived from any species. In one aspect, however, the immunoglobulin is of human, murine, or rabbit origin.

The term “linker unit” refers to the direct or indirect linkage of the antibody to the drug. Attachment of a linker to a mAb can be accomplished in a variety of ways, such as through surface lysines, reductive-coupling to oxidized carbohydrates, and through cysteine residues liberated by reducing interchain disulfide linkages. A variety of ADC linkage systems are known in the art, including hydrazone-, disulfide-and peptide-based linkages.

As used herein, the term “mass spectrometry” or “MS” refers to an analytical technique to identify compounds by their mass. MS refers to methods of filtering, detecting, and measuring ions based on their mass-to-charge ratio, or “m/z”. MS technology generally includes (1) ionizing the compounds to form charged compounds; and (2) detecting the molecular weight of the charged compounds and calculating a mass-to-charge ratio. The compounds may be ionized and detected by any suitable means. A “mass spectrometer” generally includes an ionizer and an ion detector.

In general, one or more molecules of interest are ionized, and the ions are subsequently introduced into a mass spectrometric instrument where, due to a combination of magnetic and electric fields, the ions follow a path in space that is dependent upon mass (“m”) and charge (“z”).

As used herein, the term “ionization” or “ionizing” refers to the process of generating an analyte ion having a net electrical charge equal to one or more electron units. Negative ions are those having a net negative charge of one or more electron units, while positive ions are those having a net positive charge of due to lack of one or more electron units.

As used herein, the term “chromatography” refers to a process in which a chemical mixture carried by a liquid or gas is separated into components as a result of differential distribution of the chemical entities as they flow around or over a stationary liquid or solid phase.

As used herein, the term “liquid chromatography” or “LC” means a process of selective retardation of one or more components of a fluid solution as the fluid uniformly percolates through a column of a finely divided substance, or through capillary passageways. The retardation results from the distribution of the components of the mixture between one or more stationary phases and the bulk fluid, (i.e., mobile phase), as this fluid moves relative to the stationary phase(s). Examples of “liquid chromatography” include reverse phase liquid chromatography (RPLC), high performance liquid chromatography (HPLC), ultra-high performance liquid chromatography (UHPLC), turbulent flow liquid chromatography (TFLC) (sometimes known as high turbulence liquid chromatography (HTLC) or high throughput liquid chromatography).

As used herein, the term “high performance liquid chromatography” or “HPLC” (also sometimes known as “high pressure liquid chromatography”) refers to liquid chromatography in which the degree of separation is increased by forcing the mobile phase under pressure through a stationary phase, typically a densely packed column. As used herein, the term “ultra-high performance liquid chromatography” or “UHPLC” (sometimes known as “ultra-high pressure liquid chromatography”) refers to HPLC that occurs at much higher pressures than traditional HPLC techniques.

The term “LC/MS” refers to a liquid chromatograph (LC) interfaced to a mass spectrometer.

As used herein, a reference to a “(meth)acrylate” compound (where “meth” is bracketed) is meant to include both acrylate and methacrylate compounds.

### BRIEF DESCRIPTION OF THE DRAWINGS

FIG. 1 shows an example of the traditional approach to chromatographic separation of DARs in their native form, HIC-UV, with gradient of high to low salt concentration.

FIGS. 2A-B show an example from the literature of an approach to make the effluent from a HIC separation MS compatible by splitting the flow post column and greatly diluting it.

FIG. 3A shows chemical structures of exemplary first hydrophilic monomer or exemplary hydrophilic functional groups of the first hydrophilic monomer described herein, in accordance with various embodiments of the present disclosure.

FIG. 3B shows chemical structures of exemplary second hydrophilic monomers or exemplary less hydrophilic functional groups of the second hydrophilic monomer described herein, in accordance with various embodiments of the present disclosure.

FIG. 4A shows chemical structures of exemplary initiators or initiating groups/sites covalently attached to the surface of the solid support for ATRP polymerization, in accordance with various embodiments of the present disclosure.

FIG. 4B shows chemical structures of exemplary RAFT chain transfer agent having an initiating group/site covalently attached to the surface of the solid support for RAFT polymerization, in accordance with various embodiments of the present disclosure.

FIG. 4C shows chemical structures of exemplary NMP agents having an initiating group/site covalently attached to the surface of the solid support for NMP polymerization, in accordance with various embodiments of the present disclosure.

FIG. 5 shows abbreviations for exemplary ADCs and the constituents thereof, in accordance with various embodiments of the present disclosure.

FIG. 6 shows chromatograms obtained from analysis of a sample of a model ADC (brentuximab vedotin) using the control chromatography column V1 (having silica particles coated with a homopolymer of 100% MMA) according to EXAMPLE 2, wherein the top chromatogram is a chromatogram with MS detection, the middle chromatogram is a chromatogram with UV detection at 280 nm wavelength, and the bottom chromatogram is a chromatogram with UV detection at 215 nm wavelength.

FIGS. 7A-7E show the deconvoluted mass spectra for the peaks labeled in FIG. 6. FIG. 7A shows the mass spectrum of D0; FIG. 7B shows the mass spectrum of D1; FIG. 7C shows the mass spectrum of D2; FIG. 7D shows the mass spectrum of D3; FIG. 7E shows the mass spectrum of D4.

FIG. 8A-8G show chromatograms obtained from analysis of a proprietary ADC using the prototype chromatography column V2 (having silica particles coated with HEMA:MMA 1:1.3 molar ratio) according to EXAMPLE 2, wherein the top one is a chromatogram with MS detection, the middle one is a chromatogram with UV detection at 280 nm wavelength, and the bottom one is a chromatogram with UV detection at 215 nm wavelength.

FIG. 9A-9F show results obtained from the analysis of an ADC mimic using the prototype 2 (or V2) chromatography column (surface chemistry HEMA:MMA, 1:1.3 molar ratio) according to EXAMPLE 2. FIG. 9A: HRMS (top) and UV@280 nm (bottom) chromatograms. FIGS. 9B-9F are deconvoluted spectra for the various DAR species.

FIG. 10A-10F show results obtained from the analysis of an ADC mimic using the prototype 3 chromatography column (with surface chemistry HEMA:MMA 1:2, molar ratio) according to EXAMPLE 2. FIG. 10A: HRMS (top) and UV@280 nm (bottom) chromatograms. FIGS. 10B-10F are deconvoluted spectra for the various DAR species.

FIG. 11A-11C show the LC-HRMS XIC (XIC=extracted ion current) chromatograms from the analysis of the commercial ADC Polivy™ (polituzumab vedotin-piiq) using three different prototype columns, each with a different polymer composition.

FIG. 12A-12I show detailed LC-HRMS results from analysis of the commercial ADC Polivy™ (polituzumab vedotin-piiq) on Prototype 2 column.

### DETAILED DESCRIPTION

The present disclosure generally relates to chromatography compositions and methods for separation of biomolecules, in particular, stationary phases and chromatography columns for improved separation and resolution of ADCs.

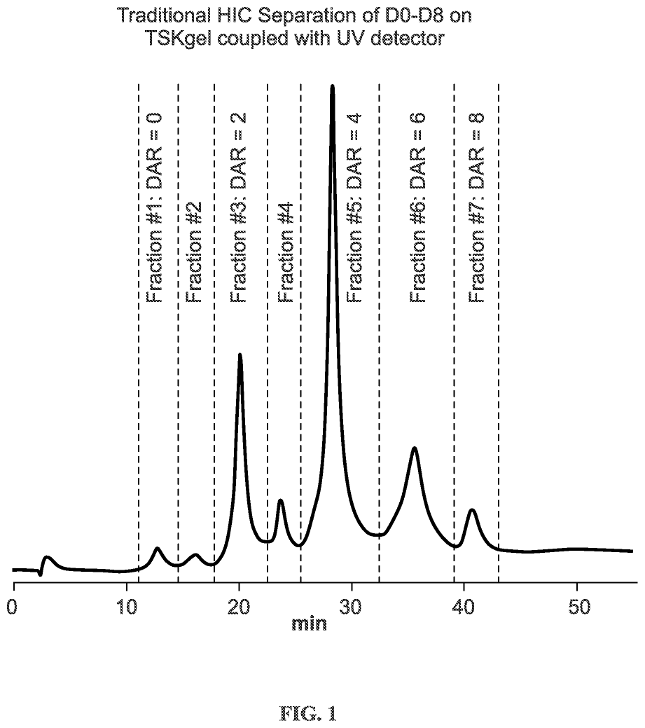

In the design, manufacture, and therapeutic use of ADCs, the average DAR of the ADCs as well as the relative amount of each ADC species (e.g. D0-D8) are important quality parameters. Traditional Liquid chromatography (LC) methods have been used to separate ADCs and to characterize the DAR and drug loading distribution. For example, reversed-phase liquid chromatography coupled to mass spectrometry (RPLC-MS) has been used to determine the average drug-to-antibody ratio (DAR) by separating the denatured subunits of the reduced ADC (Fekete, 2016), but this approach loses information about the drug load distribution. Hydrophobic interaction chromatography (HIC) based on nondenaturing separation has been used for resolving the drug distribution of ADCs (Wiggins, 2015). However, the HIC based methods employed a gradient of decreasing salt concentration for elution FIG. 1, and the high initial concentration and low volatility of the salts prevent its direct coupling to mass spectrometry for peak identification.

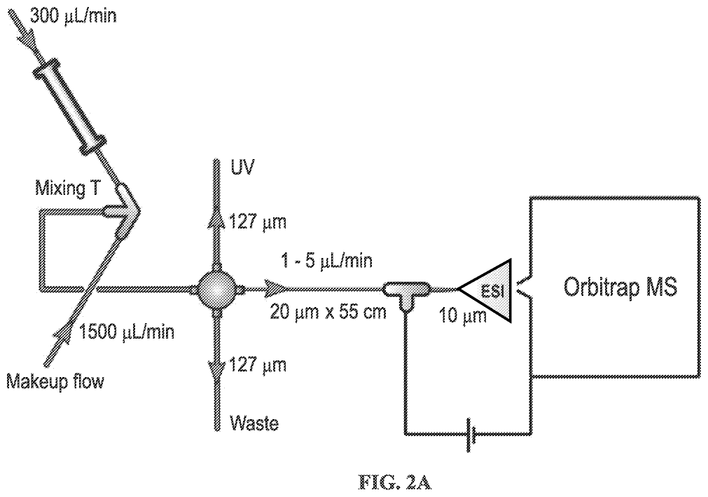

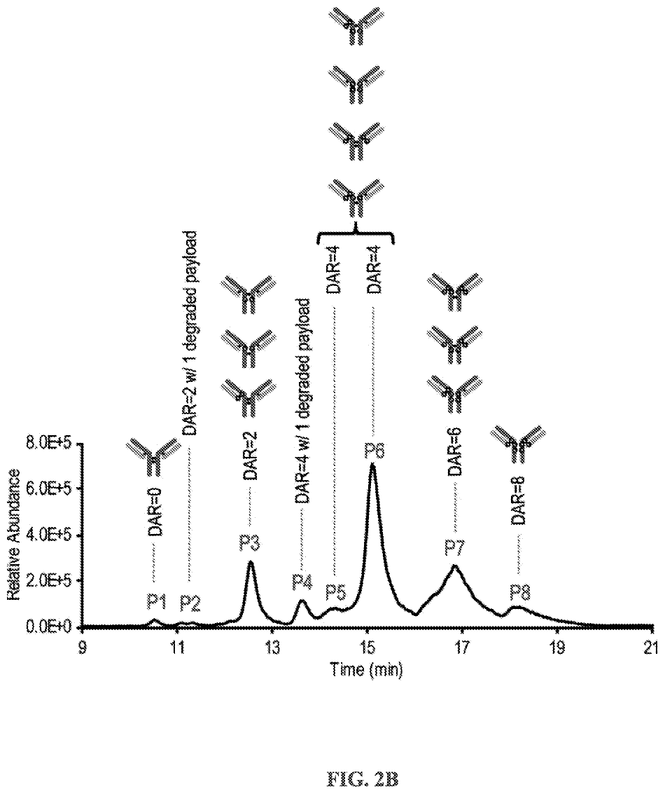

Another HIC-MS method using a makeup and splitting flow strategy was developed (Y. Yan, 2020) based on various designs of a post-column makeup and splitting flow platform to reduce the salt concentration by six folds and reduce the flow rate to 1-5 μL/min for NSI-MS detection. FIG. 2A shows one of the designs of post column dilution setting while FIG. 2B shows the results of ADC separation.

Recently, a nondenaturing version of reversed phase liquid chromatography (RPLC), or native RPLC, was developed for separating intact ADCs and determining their molecular weights by on-line coupled mass spectrometry (Chen, 2019). Chen reported a native RPLC method using a chromatography stationary phase comprising poly (alkyl methacrylate) homopolymer coated silica particles to determine the molecular mass and DARs for model ADCs.

In the present disclosure, it was found that a polymer coating with tuned hydrophilicity covalently attached to the surface of solid support for a chromatography stationary phase could significantly improve the separation, resolution, and quantification of intact ADCs having different drug to antibody ratios (DARs), and positional isomers, in their native state under MS compatible and native reversed phase conditions. Copolymerization of a first hydrophilic monomer (e.g., 2-Hydroxyethyl methacrylate, (HEMA)) and a second hydrophilic monomer (e.g., Methyl methacrylate, (MMA)) at various molar ratios onto solid support (e.g., non-porous silica support particles) advantageously allows tuning of the hydrophilicity of the stationary phase.

Retention of native antibody (DAR=0 or D0) beyond the column void and baseline resolution of ADCs with various DARs can be achieved using complimentary phases comprising copolymer-coated solid support, with lower testing pressure, faster analyses, and/or less organic modifier. With incorporation of hydrophilic functionalities in the copolymers and a tuned hydrophilicity of the polymer coating, the present stationary phase allows elution of high DAR species (e.g., DAR=8 or D8) under native reverse phase conditions, unlike those coated with poly (alkyl methacrylate) without first hydrophilic monomers and/or without tuned hydrophilicity. Additionally, the traditional separation approach for determining the DAR value of ADCs is hydrophobic interaction chromatography, or HIC, with UV detection. However, HIC methods use high concentrations of salt making them incompatible with online mass spectrometry. With HIC, fractions are collected as indicated by the vertical lines in FIG. 1 and those fractions are desalted prior to off-line MS analysis. In contrast, the present chromatography and related methods advantageously avoid use of high salt concentrations allowing direct coupling to MS for on-line operations greatly simplifying analysis and improving data quality.

### Chromatographic Stationary Phases

In some aspects, the present disclosure provides a chromatographic stationary phase comprising: a solid support; and a polymer coating on a surface of the solid support. The polymer coating comprises a copolymer comprising a first hydrophilic monomer (monomeric unit) and a second hydrophilic monomer (monomeric unit), wherein the copolymer has a tuned hydrophilicity determined by a molar ratio of the first hydrophilic monomer to the second hydrophilic monomer. The first hydrophilic monomer and the second hydrophilic monomer are different monomers and have different hydrophilicity in relation to each other. The second hydrophilic monomer has a lower hydrophilicity than the first hydrophilic monomer.

The solid support may be selected from a plurality of support particles, capillary column, a multi-capillary column, a glass column, a stainless-steel column, a monolith, or any combinations thereof.

In some embodiments, the present solid support comprises a plurality of support particles. The support particles can be any support particles capable of being used with one of the chromatography techniques and capable of forming or growing a polymer coating thereon. The support particles may be organic or inorganic or composite particles including but not limited to: silica particle, polymer bead, glass bead, alumina particle, titania particle, zirconia particle, magnetite particle iron oxide particle, or combinations thereof, such as silica cladded with zirconia, or iron oxide-silica complex particles (e.g., silica particles coated onto the surface of the iron oxide particle). In certain embodiments, the support particles comprise or consist essentially of silica (silicon dioxide particle). In some embodiments, supports other than particles can be used, including monolithic silica and 3D printed columns.

The support particles used herein may have a certain hardness or rigidity, such as hard-sphere silica particles. In some embodiments, the particles can be porous or non-porous. In other embodiments, the particles are non-porous or substantially non-porous. A hard particle is one that does not compress under pressures used in chromatography, for example pressures that range from about 1,000 to about 25,000 psi. The size of the support particles can vary depending on the size of the column to be packed. In certain embodiments, the particle size is at least about 0.1 μm, at least about 0.5 μm, at least about 1 μm, at least about 5 μm, at least about 10 μm, at least about 20 μm, at least about 30 μm, at least about 40 μm, at least about 50 μm. In certain embodiments, the support particles have an average particle size of about 0.5 μm to about 50 μm, or from about 1 μm to about 40 μm, or from about 5 μm to about 30 μm, or from about 10 μm to about 20 μm. The support particles can be spherical or irregular in shape.

The solid support may have a surface comprising a plurality of functional groups covalently attached thereto. The functional groups may comprise at least one of hydroxyl, amino, carboxylic, sulfonic, phosphoric, or any combinations thereof. For example, the support particles may be non-porous silica particles having a plurality of silanol groups (Si—OH) exposed on the surface of the particles.

The surface of the solid support may be at least partially functionalized with the polymer coating (or the copolymer) through a covalent linkage. The covalent linkage may comprise at least one linker or spacer having 1 atom to about 100 atoms, or from 2 atoms to about 50 atoms, or from 3 atoms to about 20 atoms. The covalent linker(s) may have at least two ends respectively connect the polymer coating on one end and at least one of the functional groups on the surface of the solid support on the other end. Non-limiting examples of the covalent linkage include: ether (—O—), amine (—N(R)—), carbonyl (—C(═O)—), siloxane (—Si—O—Si—), carboxylic ester (—C(═O)O—), alkyl (—(CH₂)n-), ethylene glycol (—(CH₂—O)—), carboxylic amide (—C(═O)N(R)—), an aliphatic linkage, an aromatic linkage, or any combinations thereof. In some embodiments, the polymer coating comprises a plurality of copolymers, wherein each copolymer is covalently attached to the surface of the solid support via at least one of the covalent linkers or spacers.

The copolymer of the present polymer coating is a product of copolymerization of at least two monomers, wherein at least one monomer is a first hydrophilic monomer, and at least one monomer is a second hydrophilic monomer. The copolymer may be a linear copolymer, a branched copolymer, a star polymer, a random copolymer, a statistical copolymer, a block copolymer, a bottle brush polymer, or any polymer architectures commonly known in the art.

In some embodiment, the copolymer is a product of radical copolymerization of at least one first hydrophilic monomer and at least one second hydrophilic monomer. The first hydrophilic monomer comprises at least one polymerizable group covalently coupled to at least one hydrophilic functional group. The second hydrophilic monomer comprises at least one polymerizable group covalently coupled to at least one less hydrophilic functional group. In some embodiments, the polymerizable group of the monomer is an ethylenically (—C(R)═C(R)—, R═H, methyl, or alkyl) unsaturated group, including but not limited to vinyl group, acrylate group, methacrylate group, acrylamide group, methacrylamide group, styrene group, or derivatives and analogues thereof. Non-limiting examples of the hydrophilic functional group include polyethylene oxide, hydroxyl, dihydroxyl, multi-hydroxyl, carboxylic, sulfonic, phosphoric, amine, amide, or any combinations thereof. Non-limiting examples of the less hydrophilic functional group include: a linear or branched, or cyclic (n>3) C1 to C18 saturated or unsaturated alkyl group, an aryl group, an aromatic group, a fluorocarbon group, or any combinations thereof. In some embodiments, the present copolymer is a substantially linear polymer comprising a backbone with hydrophilic functional groups and less hydrophilic functional groups on the side chains attached to the backbone.

In particular embodiments, the first hydrophilic monomer is selected from 2-hydroxyethyl (meth)acrylate, 3-hydroxypropyl (meth)acrylate, 2,3-dihyhroxylpropyl (meth)acrylate, vinyl acetate, vinyl alcohol, sodium (meth)acrylate, tetrahydrofurfuryl (meth)acrylate, furfuryl(meth)acrylate, glycidyl (meth)acrylate, 2-(diethylamino)ethyl (meth)acrylate, 2-aminoethyl (meth)acrylate hydrochloride, 2-ethoxyethyl (meth)acrylate, 3-sulfopropyl (meth)acrylate potassium salt, glycosyloxyethyl (meth)acrylate, or derivatives thereof, or any combinations thereof.

In particular embodiments, the second hydrophilic monomer is selected from alkyl(meth)acrylate, (alkyl=Me, Et, n-Pr, i-Pr, n-Bu, s-Bu, t-Bu, etc.), hexyl (meth)acrylate, cyclohexyl (meth)acrylate, 2-ethylhexyl (meth)acrylate, lauryl (meth)acrylate, stearyl (meth)acrylate isodecyl (meth)acrylate, isobornyl (meth)acrylate, phenyl (meth)acrylate, 2-naphthyl (meth)acrylate, 9-anthracenylmethyl (meth)acrylate, 2,2,3,4,4,4-hexafluorobutyl(meth)acrylate, octadecyl (meth)acrylate, styrene, or derivatives thereof, or any combinations thereof.

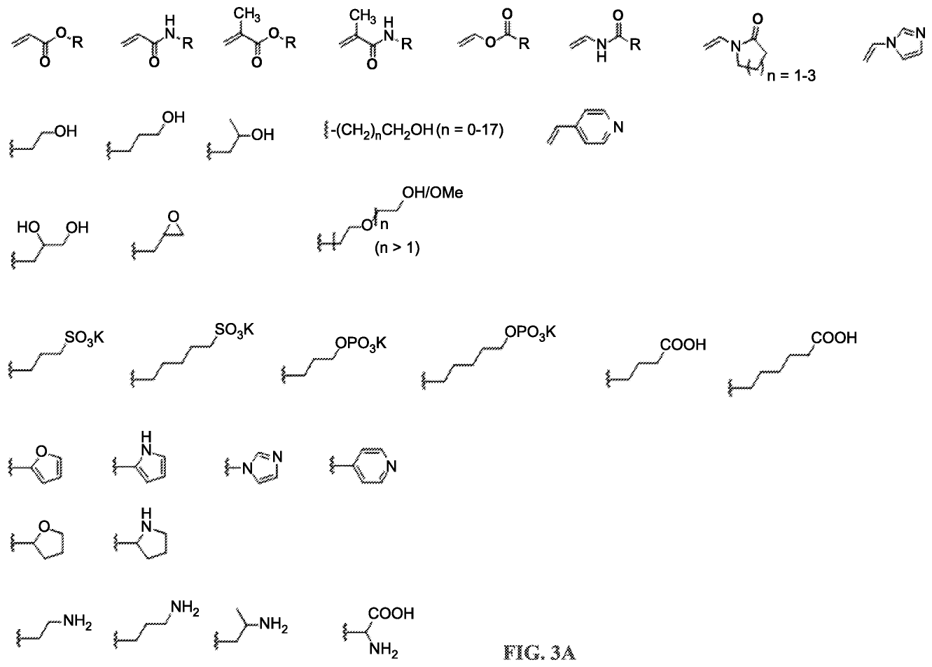

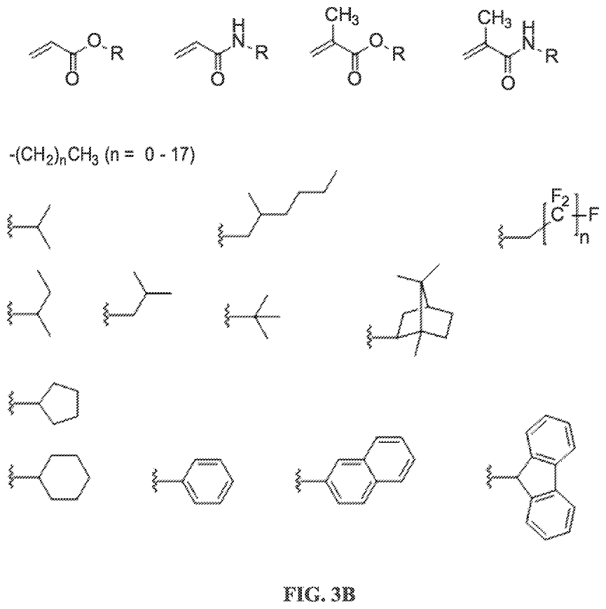

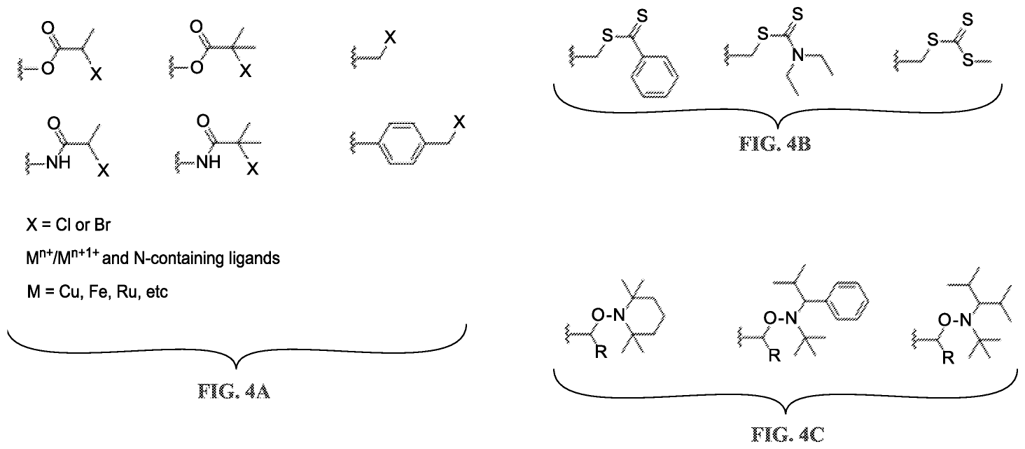

Chemical structures of non-limiting examples of the first hydrophilic monomer or hydrophilic functional group of the first hydrophilic monomer are provided in FIG. 3A. Chemical structures of non-limiting examples of the second hydrophilic monomer or less hydrophilic functional group of the second hydrophilic monomer are provided in FIG. 3B.

In some embodiment, the present copolymer has a molar ratio of the first hydrophilic monomer (monomeric unit) to the second hydrophilic monomer (monomeric unit) from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1. In some embodiment, the second hydrophilic monomeric unit has a molar percentage of at least about 1 mol %, at least about 5 mol %, at least about 10 mol %, at least about 20 mol %, at least about 30 mol %, at least about 40 mol %, at least about 50 mol %, at least about 60 mol %, at least about 70 mol %, at least about 80 mol %, at least about 90 mol %, at least about 95 mol %, at least about 99 mol %, or at least about 99.9 mol %, based on the total mole of the monomeric unit of the copolymer. In certain embodiments, the first hydrophilic monomeric unit has a molar percentage of at most about 99 mol %, at most about 95 mol %, at most about 90 mol %, at most about 80 mol %, at most about 70 mol %, at most about 60 mol %, at most about 50 mol %, at most about 40 mol %, at most about 30 mol %, at most about 20 mol %, at most about 10 mol %, at most about 5 mol %, at most about 1 mol %, or at most about 0.1 mol %, based on the total mole of the monomeric unit of the copolymer.

In some embodiments, the present copolymer has a molar ratio of the hydrophilic functional group (derived from the first hydrophilic monomer) to the less hydrophilic functional group (derived from the second hydrophilic monomer) from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

The present copolymer advantageously provides a tuned hydrophilicity of the polymer coating on the surface of the solid support by selecting the type of the hydrophilic/second hydrophilic monomer and controlling/adjusting the molar ratio thereof. As discussed above, the tuned hydrophilicity may be critical under circumstances for improving separation and resolution of ADCs. Depending on the nature and chemical/physical properties of the ADCs or the constituting antibody and drugs thereof, the hydrophilicity of the copolymer (or the polymer coating) may be tuned/adjusted in response to the surface property of the ADCs so as to reduce or minimize unfavorable interaction between the ADCs and the solid support and to maintain the structure of the ADCs intact. The polymer coating with tuned hydrophilicity thus provides an effective solution for separating and resolving native ADCs without structural disruption, dissociation and antibody denaturation.

In some embodiments, the solid support is coated with copolymers having varied molar ratios of the first hydrophilic monomer to the second hydrophilic monomer across the surface thereof. In some examples, at least a first portion of the surface is coated with a copolymer having a first molar ratio of the first hydrophilic monomer to the second hydrophilic monomer, at least a second portion of the surface is coated with a copolymer having a second molar ratio of the first hydrophilic monomer to the second hydrophilic monomer, wherein the first molar ratio and the second molar ratio are not the same.

In particular embodiments, the solid support comprises a plurality of support particles having the polymer coating covalently attached to the surface of each support particle. The polymer coating may have copolymers with varied molar ratios of the first hydrophilic monomer to the second hydrophilic monomer. In some examples, at least a first portion of the support particles are coated with a copolymer having a first molar ratio of the first hydrophilic monomer to the second hydrophilic monomer, at least a second portion of the support particles are coated with a copolymer having a second molar ratio of the first hydrophilic monomer to the second hydrophilic monomer, wherein the first molar ratio and the second molar ratio are not the same. For example, the first molar ratio is about 1:2, and the second molar ratio is about 2:1. In some embodiments, the molar ratios of the hydrophilic/second hydrophilic monomer on the surface of the support particles are varied across the support particles, ranging from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1. In some embodiments, the molar ratios of the first hydrophilic/second hydrophilic functional groups derived from the polymer coating are varied across the support particles, ranging from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1.

In particular embodiments, the present polymer coating comprises a copolymer of 2-hydroxyethyl methacrylate (HEMA) and methyl methacrylate (MMA), wherein the molar ratio of HEMA to MMA is ranging from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1.

The polymer coating comprising the copolymer having tuned hydrophilicity may be generated and attached to the surface of the solid support using any method known to one skilled in the art. In some embodiments, the polymer coating can be formed or grown on solid support. The solid support may have surface chemistry and/or initiating group/site that enables attachment of polymer chains via “grafting from” or “grafting onto” strategies commonly known in the art.

In some embodiment, the support particles may have an initiating group/site capable of generating an initiating radical, initiating the polymerization, and propagating the polymer chain to form the present copolymer. In some embodiments, the initiating group/site is introduced to the surface of the solid support by covalently attaching a radical initiator having an initiating group/site to at least one functional group (e.g., hydroxyl group (—OH) or silanol group (—Si—OH)) on the solid surface. For example, the initiator may contain a chlorosilane group or an alkoxysilane group that allows for covalent binding to a silica surface, or a functionality that can bind to a silane or silanol on the surface of the solid support. The initiator or the initiating group/site may be used to initiate the formation of the polymer coating on the support particles.

In some embodiments, the copolymer is grafted from the surface of the solid support via conventional (uncontrolled) radical copolymerization. In certain embodiments, the solid support has an polymerizable group covalently attached to the surface thereof, and the copolymer is generated by copolymerization of the first hydrophilic monomer and the second hydrophilic monomer initiated from the polymerizable group on the surface of the solid support. For example, the polymerizable group may be an ethylenically (—C═C) unsaturated group, which generates an initiating radical (—C—C) under polymerization condition, and the initiating radical initiates and propagate polymer chain growth to generate the copolymer.

In some embodiments, the copolymer is grafted from the surface of the solid support vialiving/controlled radical copolymerization (L/CRP) of the first hydrophilic monomer and the second hydrophilic monomer. Non-limiting examples of L/CRP include atom-transfer radical polymerization (ATRP) or activator regeneration ATRP, nitroxide-mediated radical polymerization (NMP), or reversible addition-fragmentation chain-transfer (RAFT). Surface-initiated L/CRP methods are generally known in the art and can be found in the publication titled “Functional Interfaces Constructed by Controlled/Living Radical Polymerization for Analytical Chemistry” (Wang, 2016), which is hereby incorporated by reference in its entirety.

In some embodiments, the copolymer is grafted from the surface of the solid support via ATRP. The ATRP used in the present disclosure also encompasses any enhanced or modified ATRP methods including but not limited to initiators for continuous activator regeneration ATRP (ICAR-ATRP), activators regenerated by electron transfer (ARGET) ATRP,, activators generated by electron transfer (AGET) ATRP, supplemental activator and reducing agent ATRP (SARA-ATRP), electrochemically mediated atom transfer radical polymerization (eATRP), and photoinduced ATRP. Methods of surface-initiated ATRP are generally known in the art and can be found in the publication titled “Surface-Initiated Radical Polymerization on Porous Silica” (Huang, 1997), the relevant part of which is hereby incorporated by reference. The ATRP initiator can be any compound capable of being attached or bound to the solid support and initiating the formation of the polymer coating on the solid support. Commonly known initiators are provided in the publication titled “Functional polymers by atom transfer radical polymerization,” (Coessens, 2001), the disclosure of which is hereby incorporated by reference in its entirety. The ATRP initiator may be selected from, but are not limited to: (chloromethyl) phenylethyl)trimethoxysilane, (3-trimethoxysilyl) propyl 2-bromo 2-methylpropionate, [11-(2-bromo-2-methyl)propionyloxy]undecyltrichlorosilane, cyanomethyl [3(trimethoxysilyi)propyl]trithiocarbonate (it's a RAFT agent), tnethoxyaminopropylsilane, glycidoxypropyltrimethoxysilane, (these are not ATRP initiators) or combinations thereof. As discussed above, the ATRP initiator may be covalently attached to the surface of the solid support, and the ATRP initiating group/site initiates the polymer chain growth to generate the desired copolymer. The ATRP initiator may become a part or all of the linker/spacer that connects the copolymer and the solid support. The ATRP polymerization may employ a transition metal complex known in the art as the catalyst with an alkyl halide as the initiator (R-X). Non-limiting examples of the ATRP catalyst include transition metal complexes such as those of Cu, Fe, Ru, Ni, and Os.

In some embodiments, the copolymer is grafted from the surface of the solid support via RAFT. Similar to ATRP, one or more RAFT chain transfer agents may be covalently attached to the surface of the solid support. The RAFT chain transfer agent may be activated to generate a RAFT radical that mediates and propagates the copolymerization to produce the desired copolymer on the surface of the solid support. The RAFT chain transfer agents used herein include but are not limited to dithioesters, dithiocarbamates, trithiocarbonates, xanthates, or any derivatives thereof. In a particular embodiment, the RAFT chain transfer agent is cyanomethyl [3-(trimethoxysilylpropyl] trithiocarbonate.

In some embodiments, the copolymer is grafted from the surface of the solid support via NMP. Similar to ATRP, one or more NMP agent containing a nitroxide group (such as alkoxyamine) may be covalently attached to the surface of the solid support. The NMP agent may be activated to generate a nitroxide radical (R2N—O·) that mediates and propagates the copolymerization to produce the desired copolymer on the surface of the solid support. The NMP agents used herein include but are not limited to N-tert-butyl-N-(1-diethylphosphono-2,2-dimethylpropyl) nitroxide (SG1) and/or its alkoxyderivative, 2,2,5-trimethyl-4-phenyl-3-azahexane-3-nitroxide (TIPNO), 2,2,6,6-tetramethyl-1-piperidinyloxy (TEMPO) based alkoxyamine, Non-limiting examples of the ATRP initiator, RAFT chain transfer agent, and NMP agent that are attached to the surface of the solid support are provided in FIGS. 2A-2C.

The amount of initiating group/site on the surface of the solid support can vary depending on the type of the initiator, the solid support particles, the polymer coating and other factors. The amount of initiating group/site can be about at least about 0.05, at least about 0.1, at least about 0.2, at least about 0.3, at least about 0.4, at least about 0.5, at least about 0.6. at least about 0.7 at least about 0.8, at least about 0.9, at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.0, at least about 2.1, at least about 2.2, at least about 2.3, at least about 2.4, at least about 2.5, at least about 2.6, at least about 2.7, at least about 2.8, at least about 2.9, at least about 3, at least about 3.1, at least about 3.2, at least about 3.3, at least about 3.4, or about at least about 3.5 μM/m2. These values can define a range, such about 0.1 to about 3 μM/m2.

In some embodiments, the polymer coating may be internally cross-linked via interchain cross-linking reaction of the copolymers through chain end coupling, backbone coupling, side chain coupling, or a combination thereof. The cross-linking reaction may be mediated or controlled by a thermal process or a photo process or spontaneously, during or after the copolymerization, with or without a catalyst or initiator. The cross-linked polymer coating may have an improved hardness, stability, or mechanical durability. In some embodiments, the polymer coating is not cross-linked or further treated after the copolymerization.

The present polymer coating may have a thickness from about 10 nm to about 500 nm, from about 50 nm to about 400 nm, or from about 100 nm to about 300 nm. The thickness of the polymer coating can be varied by adjusting the concentration of the initiating group/site, and/or the copolymerization conditions, e.g., temperature, time, monomer concentration, etc. In some embodiments, the thickness of the polymer is at least about 0.1, at least about 0.5, at least about 1, at least about 2, at least about 3, at least about 4, at least about 5, at least about 6, at least about 7, at least about 8, at least about 9, at least about 10, at least about 12, at least about 14, at least about 16, at least about 18, at least about 20, at least about 30, at least about 40, at least about 50, at least about 60, at least about 70, at least about 80, at least about 90, at least about 100, at least about 110, at least about 120, at least about 130, at least about 140, or at least about 150 nm. These values can be used to define a range, such as about 3 to about 20 nm, or from about 20 to about 25 nm. The density of the polymer coating can be at least about 0.005, at least about 0.01, at least about 0.05, at least about 0.1, at least about 0.5, at least about 1, at least about 2, at least about 3, or at least about 4 μmol/m2. These values can be used to define a range, such as about 0.01 to about 1 μmol/m2.

In a particular embodiment, the solid support comprises a plurality of non-porous silica particles. At least one of the silica particles is coated with polymer coating comprising the copolymer of 2-hydroxyethyl methacrylate (HEMA) and methyl methacrylate (MMA), wherein the molar ratio of HEMA to MMA is ranging from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1. The silica particle prior to copolymerization has at least one ATRP initiating group/site covalently attached to the surface thereof, and the copolymer is made by initiating copolymerization of HEMA and MMA and propagating the copolymer chain from the ATRP initiating site/group.

In some embodiments, the present disclosure provides a chromatography column comprising the stationary phases described herein. Methods for making/packing the chromatography column are described infra. In some embodiments, the chromatographic column has a length of about 1 to about 50 cm and an inner diameter of about 25 μm to about 10 cm.

It is noted that although the present stationary phases are found to be particularly efficient for resolution of native ADCs, they may also be suitable for other chromatographic applications including but not limited to size exclusion, ion-exchange, affinity, hydrophilic interaction, hydrophobic, perfusion, and reverse phase liquid chromatography for the separation of small molecules, peptides, sugars, and polysaccharides, glycans, monoclonal antibodies, proteins and other macromolecular compounds, and combinations thereof. The columns are suitable for high pressure liquid chromatography (HPLC), ultraperformance liquid chromatography (UHPLC), fast protein liquid chromatography (FPLC), solid phase extraction (SPE), liquid chromatography coupled with mass spectrometry (LC-MS), and ultrafiltration, and may also be used to separate compounds by electrophoresis, isoelectric focusing and capillary electrochromatography. Selection of a separation material depends on the intended use of the column and the size of the sample. The particles of the separation material may range in size from about 100 nm to about 10 μm, or about 300 nm to about 2 μm, or from about 300 nm to about 900 nm.

### Methods for Making the Stationary Phases

In some respects, the present disclosure provides a method for making the chromatography column described herein. In one example, a method comprises: (1) providing a solid support for a chromatography column; and (2) forming a polymer coating on a surface of the solid support, wherein the polymer coating comprises a copolymer comprising a first hydrophilic monomer and a second hydrophilic monomer, wherein the copolymer has a tuned hydrophilicity determined by a molar ratio of the first hydrophilic monomer to the second hydrophilic monomer. In some embodiments, forming the polymer coating comprises of the copolymer covalently attached to the surface of the solid support via a linker/spacer.

In some embodiments, forming the polymer coating comprises grafting/growing the copolymer from the surface of the solid support via radical copolymerization of the hydrophilic and second hydrophilic monomers using an initiator or an initiating group/site covalently attached to the surface of the support particle. In some embodiments, the method further comprises covalently attaching at least one initiator or a molecule having at least one initiating group/site onto the surface of the solid support prior to copolymerization. The radical copolymerization may be any conventional polymerization methods or living/controlled polymerization (L/CRP) methods described supra. The initiating group/site attached to the surface of the solid support may be derived from a polymerizable group (such as C═C bond), an ATRP initiator, a RAFT chain transfer agent, an NMP agent, or any combinations thereof, as described supra.

In some embodiments, the solid support comprises a plurality of support particles, and the method comprises: packing the chromatography column with the support particles; and forming a polymer coating on a surface of at least one support particle. In some embodiments, forming a polymer coating further comprises grafting/growing the copolymer from the surface of the support particle. The copolymer may be grafted on the support particle before, after, or before and after the chromatography column is packed. Conventional column packing methods may be used in combination with the present disclosure to make the present chromatography column. One common technique of forming packed chromatography column is to produce a slurry of the support particles inside the column and then using high solvent flow through the column to push the support particles towards the outlet of the column. To produce these columns using the slurry technique, the chromatographic column is open at the top during the packing process and this end is attached to one end of a slurry chamber. The chromatographic media slurry fills the slurry chamber and the column tube. The outlet end of the column holds the frit that retains the chromatographic media but permits the liquid to exit the column. The inlet end of the slurry chamber is attached to a high pressure, high volume pump that forces a liquid through the chamber.

The high flow liquid forces the particles to migrate towards the exit of the column and the chromatographic media is slowly compressed into a uniform and dense bed. In some embodiments, a method for making a chromatography column comprises: (1) providing a plurality of non-porous silica particles for a chromatography column, wherein the non-porous silica particles have at least one initiating group/site covalently attached to the surface thereof; (2) initiating copolymerization of a first hydrophilic monomer and a second hydrophilic monomer from the initiating group/site to generate a polymer coating comprising copolymers of the first hydrophilic monomer and the second hydrophilic monomer on the surface of the support particles; (3) placing the copolymer coated non-porous silica particles into the chromatography column and packing the chromatography column, wherein the copolymer has a tuned hydrophilicity determined by a molar ratio of the first hydrophilic monomer to the second hydrophilic monomer, wherein the molar ratio is from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1. In some embodiments, first hydrophilic monomer is HEMA and the second hydrophilic monomer is MMA. In some embodiments, the copolymer is generated by surface-initiated ATRP.

Alternatively, the polymer coating can be formed or grown on the packed support particles, adopting an “in situ” approach known in the art. Generally, the chromatography column is packed with support particles to form packed support particles within the column; and a polymer coating on the packed support particles is subsequently formed by grafting polymers directly from the packed support particles. General examples of the “in situ” approach can be found in U.S. Patent Publication No. 20190257801, the relevant part of which is incorporated herein.

In particular embodiments, a method for making a chromatography column comprises:
(1) providing a plurality of non-porous silica particles for a chromatography column, wherein the non-porous silica particles have at least one initiating group/site covalently attached to the surface thereof; (2) placing the coated non-porous silica particles into the chromatography column and packing the chromatography column, and (3) initiating copolymerization of a first hydrophilic monomer and a second hydrophilic monomer from the initiating group/site to generate a polymer coating comprising copolymers of the first hydrophilic monomer and the second hydrophilic monomer on the surface of the packed support particles; wherein the copolymer has a tuned hydrophilicity determined by a molar ratio of the first hydrophilic monomer to the second hydrophilic monomer, wherein the molar ratio is from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1. In some embodiments, first hydrophilic monomer is HEMA and the second hydrophilic monomer is MMA. The second hydrophilic monomer is considered to be less hydrophilic than the first hydrophilic monomer. In some embodiments, the copolymer is generated by surface-initiated ATRP.

A monomer or pre-polymer solution containing the hydrophilic/second hydrophilic monomers, catalyst, ligand, initiator, co-solvent, etc., can be introduced to the support particles in the column, such as, by introducing the monomer or pre-polymer solution to the packed column. The polymer coating can be affected by the reaction conditions and the reaction time allowed for polymerization. The polymer can grow approximately linearly with reaction time. For example, a monomer solution having a concentration of about 3 mol/L can undergo polymerization reaction for about 30 to about 60 minutes to generate a polymer coating. It is noted that a person skilled in the art could arrive at the desired molar ratio(s) of the first hydrophilic/second hydrophilic monomeric units of the copolymer by controlling the molar ratio(s) of the corresponding first hydrophilic/second hydrophilic monomers in the monomer solution, depending partially on the reactivity ratio of the monomers, copolymerization parameters, and reaction conditions. For example, surface-initiated copolymerization using a monomer solution containing a molar ratio of HEMA:MMA of about 1:1 could generate a copolymer having about the same molar ratio of the HEMA unit: MMA unit in the copolymer.

In some embodiments, the polymer coating can be monitored by measuring the backpressure over time during the “in situ” copolymerization step. The polymer coating can be grown by flowing a pre-polymer solution through the column at low rate. After initially pumping the solution into the column, the flow rate can be reduced, such as by about 50%. The pressure to maintain the reduced rate can gradually rise as the polymer coating is formed. The reaction can be allowed to proceed until the time or pressure reaches a desired value, such as up to 1 hour or about 20,000 psi. The reaction time can be about 0.1, about 0.2, about 0.3, about 0.4, about 0.5, about 0.6, about 0.7, about 0,8, about 0.9, about 1, about 1.1, about 1.2, about 1.3, about 1.4, about 1.5, about 2, about 2.5, about 3, about 3.5, about 4, about 4.,5 or about 5 hours. These values can be used to define a range, such as about 0.5 to about 2 hours. The reaction pressure can he about 1000, about 2000, about 3000, about 4000, about 5000, about 6,000, about 6,500, about 7,000, about 7,500, about 8,000, about 8,500, about 9,000, about 9,500, about 10,000, about 11,000, about 12,000, about 13,000, about 14,000, about 15,000 psi, or about 20,000 psi. These values can be used to define a range, such as about 1000 to about 12000 psi.

In some embodiments, the copolymerization reaction can be allowed to proceed at a constant pressure, such as defined above, and the reaction can be stopped at a desired flow rate. The desired flow rate can be about 0.1, about 0.5, about 1, about 5, about 10, about 20, about 30, about 40, about 50, about 60, about 70, about 80, about 90, about 100, about 110, about 120, about 130, about 140, about 150, about 160, about 170, about 180, about 190, about 200, about 250, about 300, about 350, about 400, about 450, or about 500 μL/min. These values can be used to define, a range such as about 50 to about 300 μL/min.

In some embodiments, the polymer coating can be formed without flowing a solution, e.g., a pre-polymer solution or reagent solution, through the column. The solution can be introduced to the column, initially flow through, etc., then the polymer coating can be allowed to form without flow, or constant flow, or continuous flow, through the column. The column can still be held under pressure and allowed to react, as provided above.

The chromatography columns of the present disclosure can improve resolution compared to the disclosed columns in the art. Resolution is measured by the ratio of peak distance to peak base. The chromatography columns of the present disclosure can improve resolution by about 10%, about 20%, about 30%, about 40%, about 50%, about 60%, about 70%, about 80%, about 90%, or by about 100% compared to disclosed columns in the art, such as those not having the compositions of the present disclosure. These values can be used to define a range such as about 10% to about 30%. The chromatography columns of the present disclosure can improve resolution by about 1.5 times, about 2 times, about 3 times, about 4 times, about 5 times, about 6 times, about 7 times, about 8 times, about 9 times, or about 10 times, compared to the disclosed columns in the art, such as those not having the compositions of the present disclosure. These values can be used to define a range such as about 2 times to about 4 times.

The chromatography columns of the present disclosure can have improved column-to-column reproducibility as compared to the disclosed columns in the art. The chromatography columns of the present disclosure can improve reproducibility by about 10%, about 20%, about 30%, about 40%, about 50%, about 60%, about 70%, about 80%, about 90%, or by about 100% compared to disclosed columns in the art, such as those not having the compositions of the present disclosure. These values can be used to define a range such as about 20% to about 40%. The chromatography columns of the present disclosure can improve reproducibility by about 1.5 times, about 2 times, about 3 times, about 4 times, about 5 times, about 6 times, about 7 times, about 8 times, about 9 times, or about 10 times, compared to the disclosed columns in the art, such as those not having the compositions of the present disclosure. These values can be used to define a range such as about 2 times to about 4 times.

The chromatography columns of the present disclosure can operate at flow rates up to, or more than, about 100, about 110, about 120, about 130, about 140, about 150, about 160, about 170, about 180, about 190, about 200, about 250, about 300, about 350, about 400, about 450, and up to about 500 μL/min. These values can be used to define a range such as about 160 to about 200 μL/min.

The chromatography columns of the present disclosure can improve column stability compared to the disclosed columns in the art. Column stability can be measured by the onset of column failure at high flow rate (i.e., bed collapse), which can cause accelerated aging due to the shearing. The chromatography columns of the present disclosure can improve column stability by about 10%, about 20%, about 30%, about 40%, about 50%, about 60%, about 70%, about 80%, about 90%, or by about 100% compared to disclosed columns in the art, such as those not having the compositions of the present disclosure. These values can be used to define a range such as about 20% to about 50%. The chromatography columns of the present disclosure can improve column stability by about 1.5 times, about 2 times, about 3 times, about 4 times, about 5 times, about 6 times, about 7 times, about 8 times, about 9 times, or about 10 times, compared to the disclosed columns in the art, such as those not having the compositions of the present disclosure. These values can be used to define a range such as about 2 times to about 4 times.

### Method for Analyzing ADCs

The chromatography columns according to the present disclosure are particularly suitable for native reverse phase chromatography of antibody-drug conjugates (ADCs). In some aspects, the present disclosure provides a method for analyzing ADCs using the chromatography stationary phases described herein. In one example, a method for analyzing ADCs in a sample comprises: (a) exposing the sample to a chromatographic stationary phase of a reverse phase chromatography column, and (b) applying an eluent to the chromatography column to elute the native antibody-drug conjugates, wherein the chromatographic stationary phase comprises: a solid support and a polymer coating on a surface of the solid support; wherein the polymer coating comprises a copolymer of at least one first hydrophilic monomer and at least one second hydrophilic monomer, wherein the copolymer has a tuned hydrophilicity determined by a molar ratio of the first hydrophilic monomer to the second hydrophilic monomer. In particular embodiments, the polymer coating comprises a copolymer of 2-hydroxyethyl methacrylate (HEMA) and methyl methacrylate (MMA), and wherein the molar ratio of HEMA to MMA is from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1.

In some embodiments, the method further comprises at least one of the following: separating and resolving the eluted native ADCs with the same or varied DARs (from 0 to 20), separating and resolving positional isomers of the ADCs with the same DARs; detecting and quantifying the eluted native ADCs, unconjugated antibody, fragments and dissociated ADCs, and unconjugated drug, using a detection method such as UV spectroscopy or mass spectrometry; establish a mass-to-charge (m/z) ratio or molecular mass and a DAR for at least one of the eluted native ADCs at varied DAR ratios; determining the relative quantity or concentration of each native ADC in the sample; determining the average DAR for the sample, identifying/quantifying unconjugated antibody and/or unconjugated drug in the sample. In some embodiments, the sample is not treated to denature or dissociate the ADCs and/or the antibody thereof, and the ADCs remain intact upon elution.

In some embodiments, mass spectrometry is used to establish a mass to charge ratio of each of the ADCs, the native antibody, and the unconjugated drug, in the sample. This is particularly useful in monitoring the formation and stability of the ADCs and/or quality control of the ADC production. In certain embodiments, optical spectroscopy such as ultraviolet (UV) and/or visible spectroscopy is used.

In some embodiments, the eluent (mobile phase) used in the present method has a salt concentration from about 1 mM to about 100 mM, or from about 20 mM to about 80 mM, or from about 30 mM to about 60 mM. In certain embodiments, the salt concentration is no more than about 100 mM, or no more than about 80 mM, or no more than about 60 mM. In some embodiments, the salt comprises ammonium acetate. The low salt concentration of the eluent advantageously improves MS compatibility, dispensing the need to desalt the analyte solution before MS analysis.

In some embodiments, the eluent further comprises an organic solvent such as isopropanol, wherein the organic solvent has a volume % of no more than about 80 vol %, no more than about 60 vol %, no more than about 50 vol %, no more than about 40 vol %, no more than about 30 vol %, no more than about 20 vol %, no more than about 10 vol %, no more than about 1 vol %, or about 0, based on the total volume of the eluent. These values can be used to define a range such as about 0 to about 80 vol %. In some embodiments, the eluent comprises a gradient of organic solvent from about 0 to about 50 vol %.

A variety of mass spectrometry systems capable of high mass accuracy, high sensitivity, and high resolution are known in the art and can be employed in the methods of the invention. The mass analyzers of such mass spectrometers include, but are not limited to, quadrupole (Q), , time of flight (TOF), ion trap (Orbitrap), magnetic sector or FT-ICR or combinations thereof.

The ion source of the mass spectrometer should yield mainly sample molecular ions, or pseudo-molecular ions, and certain characterizable fragment ions. Examples of such ion sources include atmospheric pressure ionization sources, e.g. electrospray ionization (ESI) and Matrix Assisted Laser Desorption Ionization (MALDI). ESI and MALDI are the two most commonly employed methods to ionize proteins for mass spectrometric analysis. ESI and APC1 are the most commonly used ion source techniques for LC/MS (Lee, M. “LC/MS Applications in Drug Development” (2002) J. Wiley & Sons, New York).

Commercially available mass spectrometers can sample and record the whole mass spectrum simultaneously and with a frequency that allows enough spectra to be acquired for a plurality of constituents in the mixture to ensure that the mass spectrometric signal intensity or peak area is quantitatively representative. This will also ensure that the elution times observed for all the masses would not be modified or distorted by the mass analyzer and it would help ensure that quantitative measurements are not compromised by the need to measure abundances of transient signals.

FIG. 5 illustrates examples of ADC with varied DARs. L0 refers to a light chain of antibody without drug load. L1 refers to a light chain of antibody with one drug/linker attachment. H0, H1, H2, and H3 respectively refer to heavy chains of antibody with 0, 1, 2, and 3 drug/linker attachment(s). D0 refers to antibody with no drug attached; D2, D4, D6, and D8 respectively refer to ADCs having 2, 4, 6, and 8 drug molecules attached.

Analysis of ADCs using prototype chromatography columns and method may generate a chromatogram such as a total ion chromatogram (TIC) or extracted ion chromatogram (EIC) showing chromatographic separation and resolution of intact ADCs with varied DARs (i.e., D0, D1, D2, D3, D4, D5, D6, D7, D8, etc.). In particular embodiments, the ADCs having high DARs

(e.g. DAR of 8 or higher) can be separated from other ADCs, readily observable, and reliably identifiable from the chromatogram and accompanying mass spectra. From the chromatograms, the concentration of each ADC in the sample as well as the relative ratios of the ADCs having different DARs may be determined and quantified, e.g., by using commercial analytical software.

In certain embodiments, the prototype chromatography column provides improved separation and resolution of ADCs having high DARs, as compared with the disclosed chromatography column in the art, such as those not having the compositions of the present disclosure. In some embodiments, the prototype chromatography columns provide improved retention of the native antibody (D0) beyond the column void, as compared with the disclosed chromatography column in the art, such as those not having the compositions of the present disclosure.

As shown in FIG. 5, certain ADCs, e.g., D2, D4, and D6 may each have various positional isomers. These ADC positional isomers associated with the same DARs may have different surface properties and degrees of interaction. When contacted with the present stationary phase, improved separation and resolution these positional isomers may be achieved.

### EXAMPLES

Certain embodiments of the present disclosure are further described with reference to the following experiments and examples. These experiments, examples, and samples are intended to be merely illustrative of the disclosure and are not intended to limit or restrict the scope of the present disclosure in any way and should not be construed as providing conditions, parameters, reagents, or starting materials that must be utilized exclusively in order to practice the art of the present disclosure.

### Example 1

Sample chromatography columns were prepared according to the general procedures described below. Installation of ATRP initiator on the surface of support particles: Non-porous silica (average particle size of about 3.1 μm, about 150 g) was added into a 1 L round bottom flask and dried in a convection oven at about 80° C. for about 3 h. Toluene (about 500 g) was added the same flask and stirred for 5 mins with an overhead stirrer. An ATRP initiator 3-Trimethoxysilylpropyl-2-Bromo-2-Methylpropionate (about 10 mL) was diluted with toluene (about 10 mL) and added to the same flask. The reaction was stirred at room temperature for about 5 min, then heated up to reflux for about 12 h and stirred overnight. The reaction mixture was filtered under vacuum, washed with toluene (about 100 mL), and continued vacuum filtration until the silica particles were dried. The silica particles were removed from the filter paper, and re-slurried in toluene (about 500 g) in a 1 L round bottom flask. Trimethylchlorosilane (about 11 mL) was added to the flask, and the reaction was heated to reflux for about 6 h and stirred overnight. The reaction mixture was filtered, washed with toluene (about 1.5 L), and continued vacuum filtration until the silica particles were dried. The surface-functionalized silica particles with ATRP initiating groups (Si—Br) were further dried in a vacuum oven at about 60° C. for about 2 days.

Preparation of polymer coated silica particles: Three solutions, solution A, solution B, and solution C were separately prepared. Solution A was prepared by mixing water (about 250 mL) and isopropyl alcohol (about 250 mL) following by degassing with N2 sparging at about 4 mL/min for about 2 h. Solution B (a blue solution) was prepared by dissolving copper chloride (about 360 mg) in about 18 mL of the degassed Solution A, and adding Tris[2-(dimethylamino)ethyl]amine (Me6TREN, about 800 μL) to the same solution. Solution C was prepared by dissolving sodium ascorbate (about 180 mg) about 18 mL of the degassed Solution A.

The surface-functionalized silica particles (Si—Br, about 30 g) and Solution A (about 300 mL) were added to a 500 mL round bottom flask. 2-Hydroxyethyl methacrylate (HEMA, about 12.5 g) and methyl methacrylate (MMA, about 12.5 g) were added to the same flask. It is noted that the ratio of HEMA to MMA could be varied to tune hydrophilicity of the resulted copolymer, depending on the requirements for HPLC separation. The mixture was degassed with N2 sparging for about 1 h. Solution B and Solution C were simultaneously added to the round bottom flask, and the reaction mixture was stirred at room temperature for about 10 min under N2 atmosphere. The reaction mixture was then filtered immediately, washed with Solution A (about 30 mL), followed by water (about 500 mL) twice, and the crude product was continued vacuum filtration overnight to dryness. Next day, the crude product was washed with 0.25 wt % EDTA solution (about 100 mL), water (about 500 mL) twice, Solution A (about 100 mL), methanol (about 100 mL), and continued vacuum filtration for 1 h to yield the copolymer coated non-porous silica particles. The final product was further dried in a convection oven at about 80° C. for about 1 h.

Preparation of chromatography column: The copolymer coated silica particles were slurry-packed by the downward flow method into a stainless-steel column (50×2.1 mm). A slurry of the copolymer coated silica particles was prepared by dispersing about 0.3 g of the copolymer coated silica particles in about 15 mL of acetonitrile, stirring the mixture for a few minutes, and optionally sonicating it for a few minutes. Acetonitrile (about 50 mL) was used as the packing solvent, and the packing pressure was about 10,000 psi to about 20,000 psi.

Three sample chromatography columns were prepared. A control (reference) column V1 (or prototype 1) coated with homopolymer of 100% MMA (without first hydrophilic monomer) was prepared. Prototype column V2 (or prototype 2) has silica particles coated with copolymer having the HEMA: MMA molar ratio of 1:1.3 (this equates to 50/50 wt % of HEMA and MMA, as shown in Example 1). Prototype column V3 (or prototype 3) has silica particles coated with copolymer having the HEMA: MMA molar ratio of 1:2.0 (this equates to 40/60 wt % of HEMA and MMA, respectively).

### Example 2

Agilent 1290 Infinity II liquid chromatograph was used for the chromatographic measurements. A model ADC (Brentuximab-Vedotin conjugate) was used for the development of chromatographic separation. The ADC samples were obtained from Seattle Genetics. The ADCs comprise antibody Brentuximab and drug conjugate Vedotin. The sample chromatography columns 1 and 2 as well as the control chromatography column prepared according to EXAMPLE 1 were used as the analytical columns, and their separation performances were compared. A mass spectrometer was coupled online to the liquid chromatograph. A gradient mobile phase based on ammonium acetate (50 mM) and isopropyl alcohol (IPA) was used to for elution. Mobile phase A (MPA) contained 50 mM ammonium acetate in water with no pH adjustment (pH ˜7) and mobile phase (MPB) contained 50 v/v % IPA and 50 v/v % 50 mM ammonium acetate in water with no pH adjustment. The gradient started with 100 vol % MPA and held at 100% MPA for 2 minutes. MPB was increased to 15 vol % MPB in 3 minutes (5 minutes total elapsed time) then to 50 vol % MPB in 15 minutes (20 minutes total elapsed time), held at 50 vol % MPB for 6 minutes (26 minutes total elapsed time), then returned to 100% MPA in 0.1 minutes and held there for 6 minutes (˜32 minutes total elapsed time). Flow rate was 0.2 mL/min, and column temperature was 30° C. Peak identities were assigned by matching deconvoluted masses with theoretical masses.

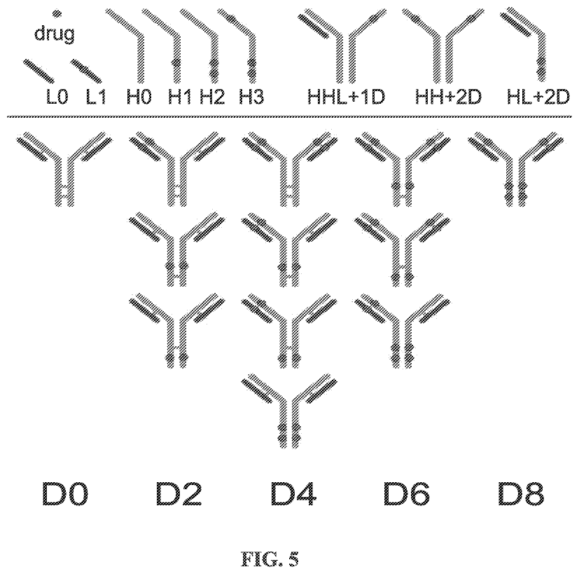

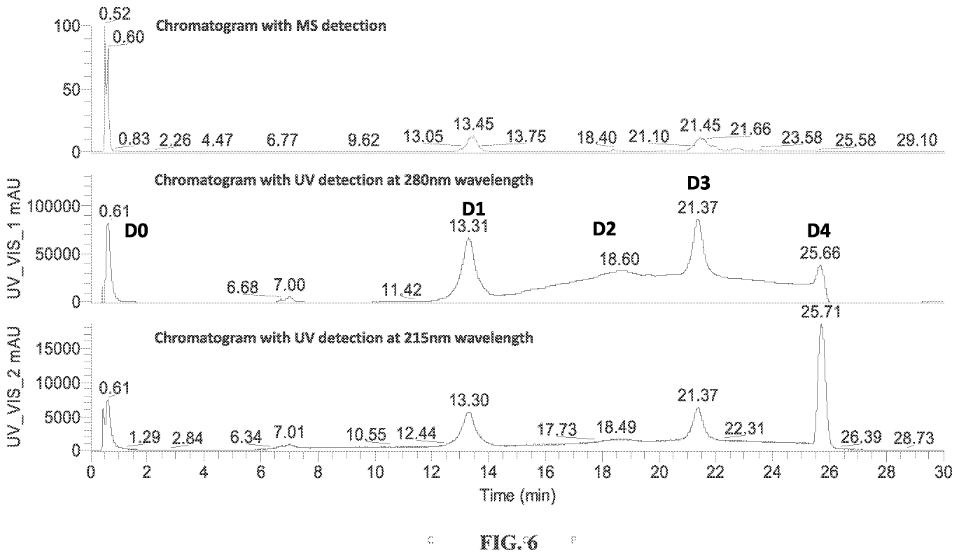

FIG. 6 shows chromatograms obtained from analysis of a model ADC using the control chromatography column V1 according to EXAMPLE 2, wherein the top chromatogram shows MS detection, the middle chromatogram shows UV detection at 280 nm wavelength, and the bottom chromatogram shows UV detection at 215 nm wavelength. In FIG. 6, the chromatograms represent analysis of a commercially available ADCs, and illustrate elution and resolution of DARs 0 to 4 drugs conjugated (D0-D4). ADC species with high drug loadings, i.e. DAR5-8, do not elute from the control column under native conditions Specifically, as shown in the middle chromatograph of FIG. 6, chromatographic resolution of intact ADCs having different DARs, e.g., D0, D1, D2, D3 and D4, and positional isomers, in their native state using MS compatible, native reversed phase conditions.

In the examples for prototype columns, chromatographic elution and resolution of higher DAR species (DAR4-DAR8) is achieved by copolymerization of HEMA with MMA at various ratios onto non-porous silica, which allows tuning of the hydrophilicity of the stationary phase. In various examples, the surface properties are controlled by using HEMA and MMA at various ratios. Retention of native antibody (D0 or DAR0) beyond the column void and baseline resolution of D1-D8 (or DAR1-DAR8) can be achieved using complimentary phases. The particle size may be optimized to allow lower testing pressure which allows faster analyses with less organic modifier. In various examples, due to the incorporation of HEMA in the surface coating, the stationary phase allows elution of high DAR species (up to DAR8 or D8) under native reverse phase conditions, which may not be possible with 100% MMA.

In various examples of the disclosure, the determination of the average DAR as well as the relative amount of each ADC species (e.g. D0-D8) may be possible. The complementary stationary phases provide a new tool to reliably determine the average DAR and the relative amount of each ADC species. The complementary phases may provide proper retention and resolution all DAR species under native reverse phase conditions. In addition, the eluents used in these separations are compatible with mass spectrometry for identification and characterization. Other techniques such as, e.g., reversed phase modalities, may be combined with mass spectrometry, but proteins may be denatured and may no longer be in native conformation.

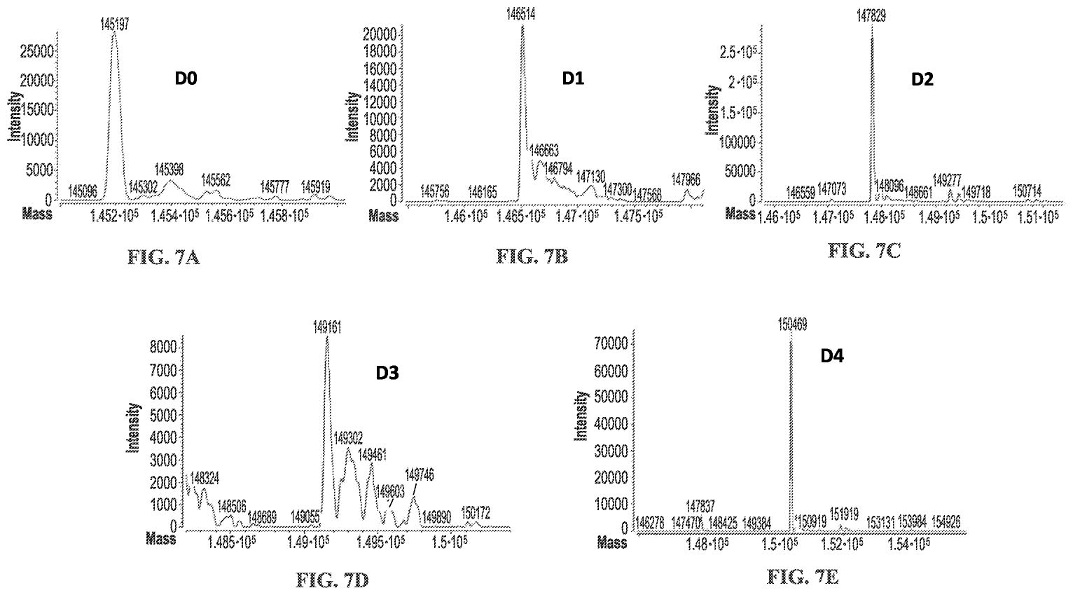

FIGS. 7A-7E show the mass spectra for peaks labeled in FIG. 6. For example, FIG. 7A shows the mass spectrum of D0; FIG. 7B shows the mass spectrum of D1; FIG. 7C shows the mass spectrum of D2; FIG. 7D shows the mass spectrum of D3; FIG. 7E shows the mass spectrum of D4.

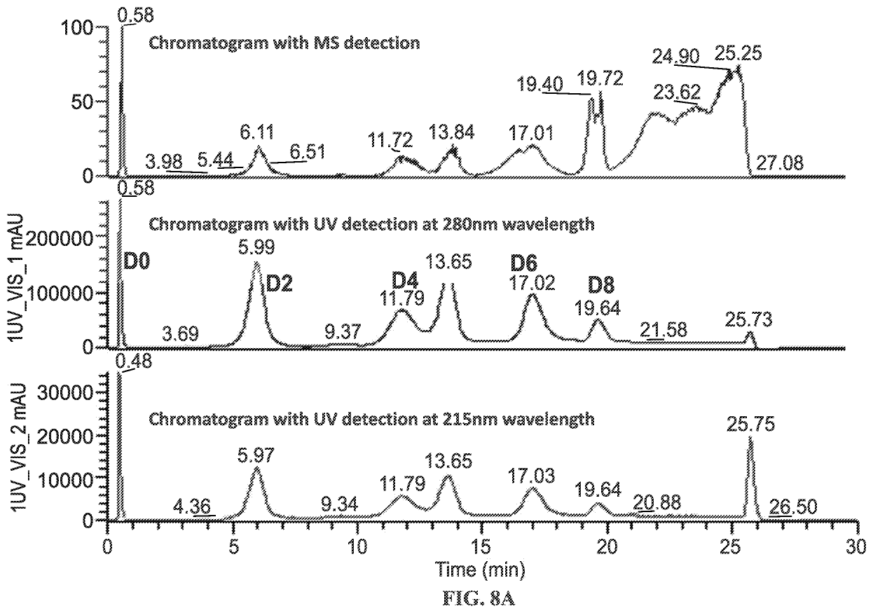

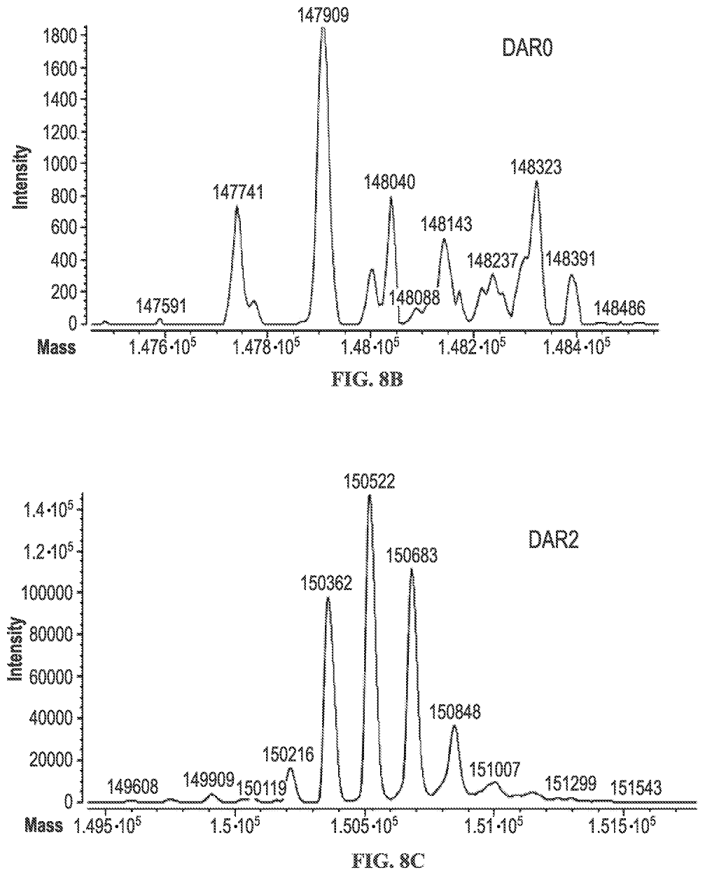

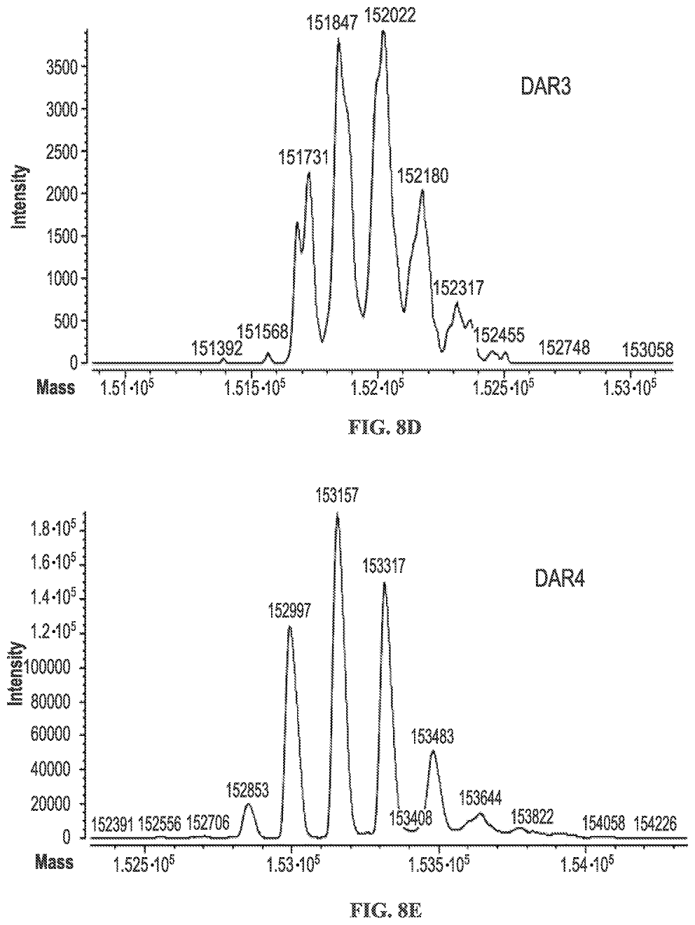

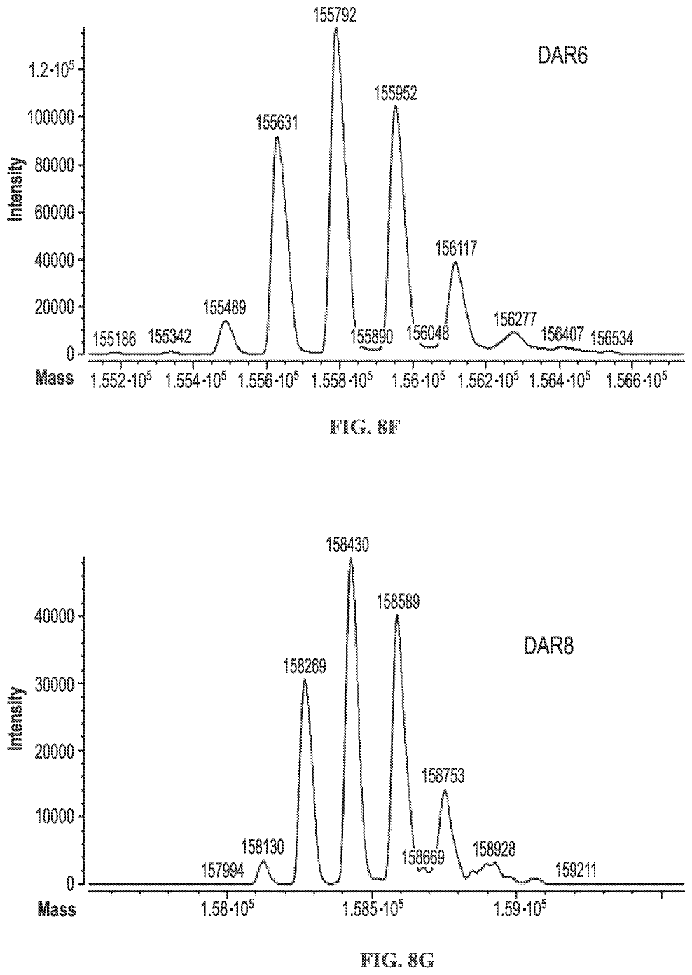

FIG. 8A-8G show chromatograms obtained from analysis of a proprietary ADC using the prototype column V2 (having silica particles coated with copolymer having the HEMA:MMA molar ratio of _1:1.3) according to EXAMPLE 2, wherein the top one is a chromatogram with MS detection, the middle one is a chromatogram with UV detection at 280 nm wavelength, and the bottom one is a chromatogram with UV detection at 215 nm wavelength.

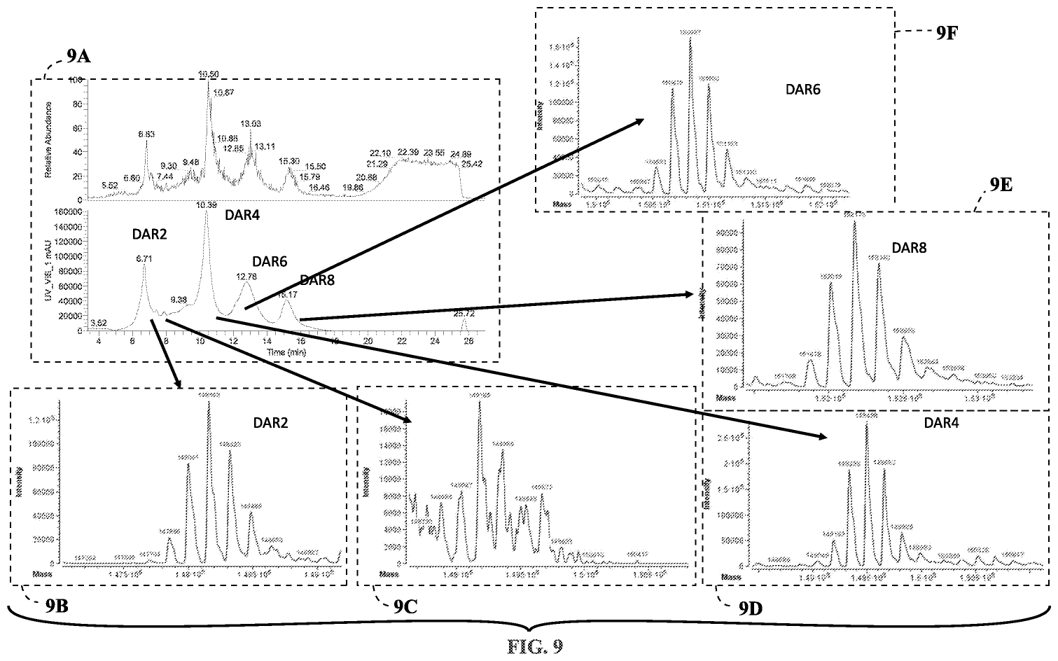

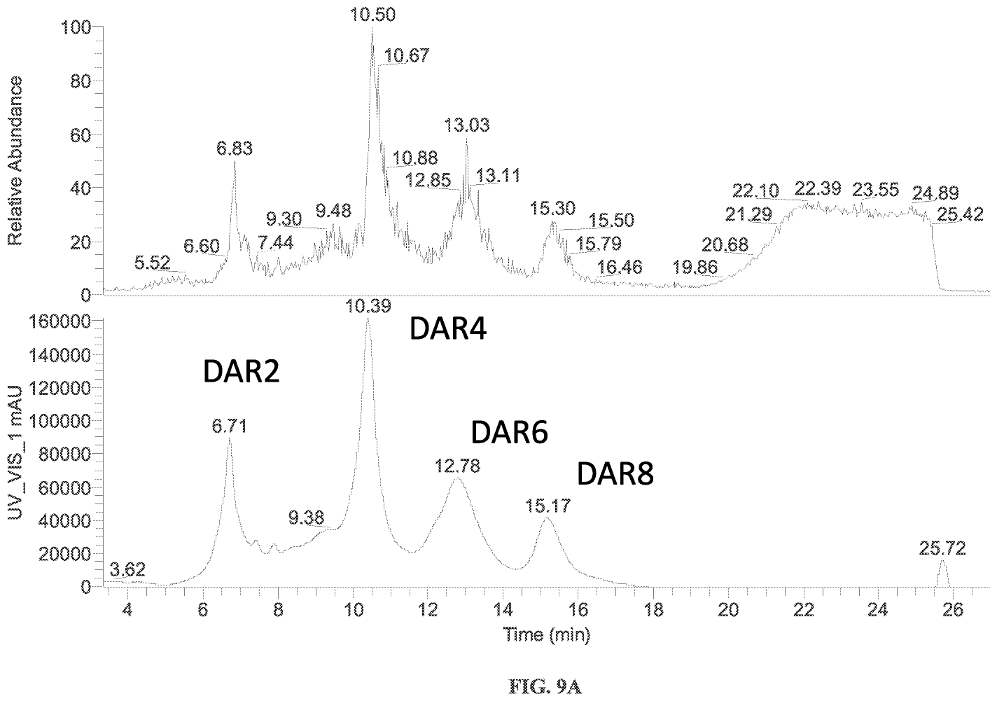

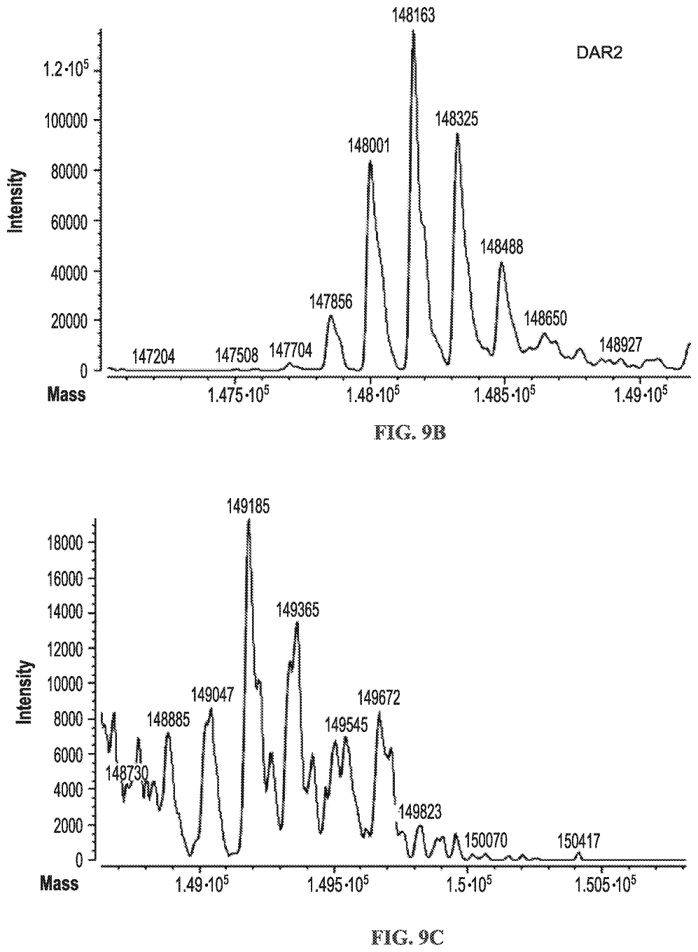

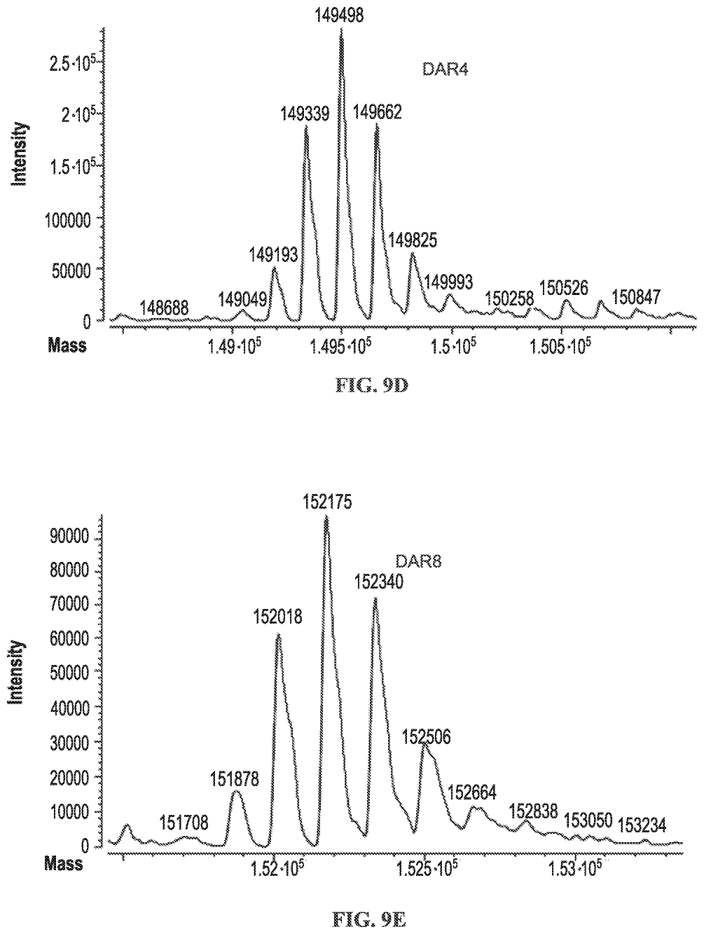

FIGS. 9A-9F show results obtained from the analysis of an ADC mimic using the prototype chromatography column V2 according to EXAMPLE 2. 9A: HRMS (top) and UV@280 nm (bottom) chromatograms. 9B-9F: Deconvoluted spectra for the various DAR species

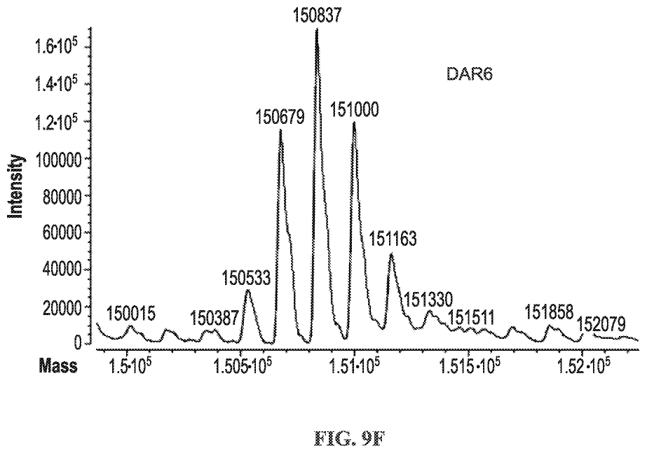

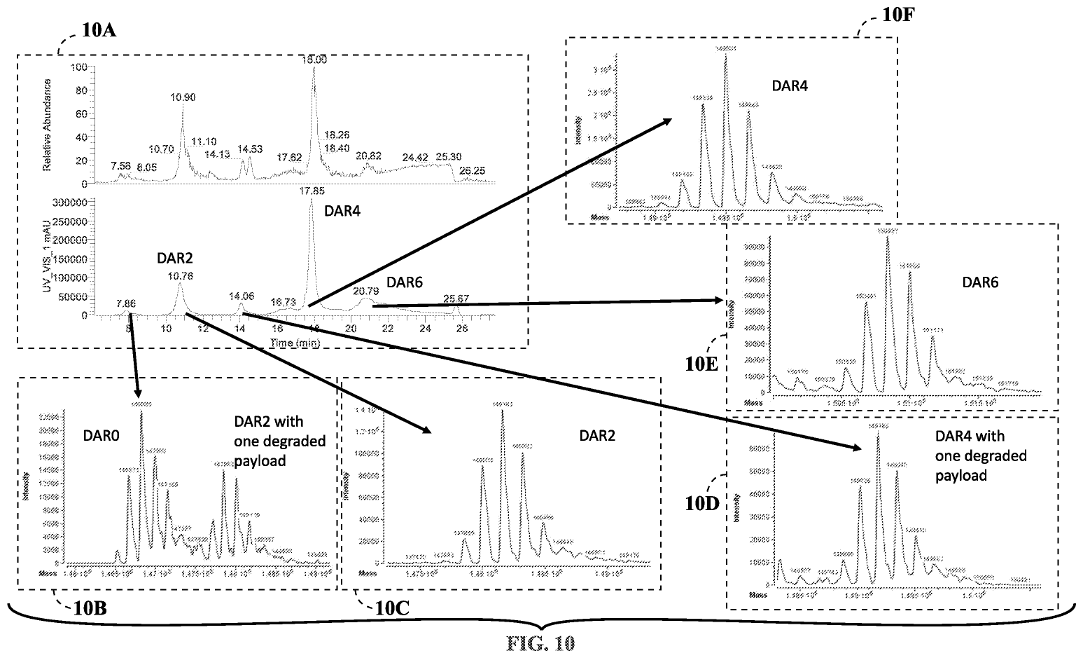

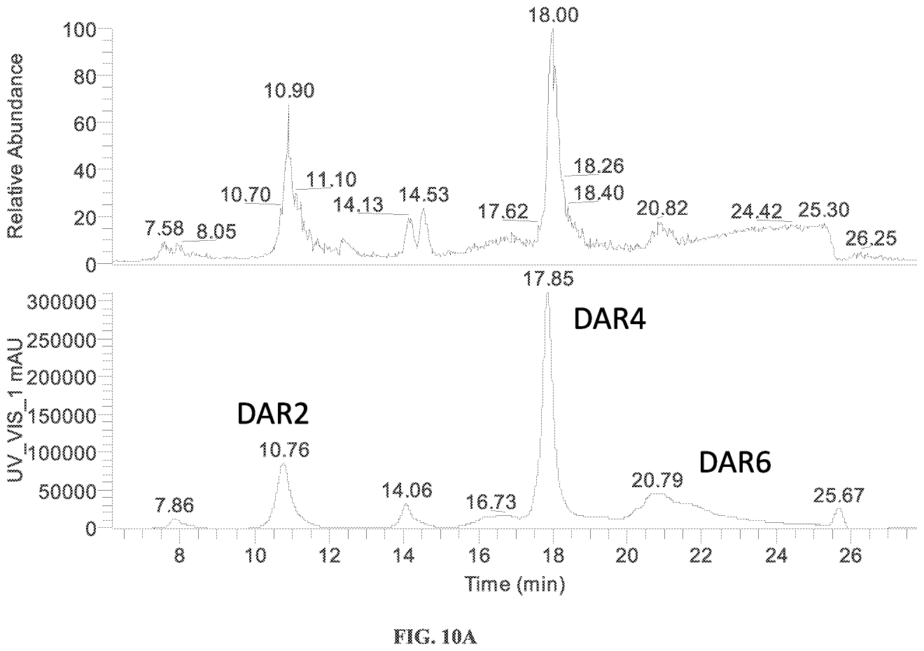

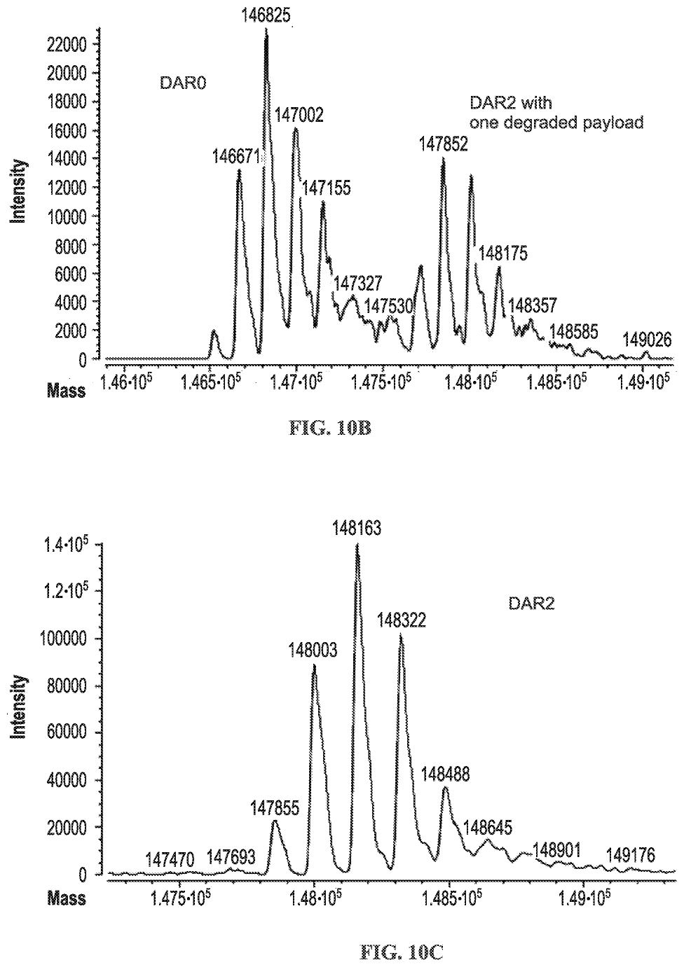

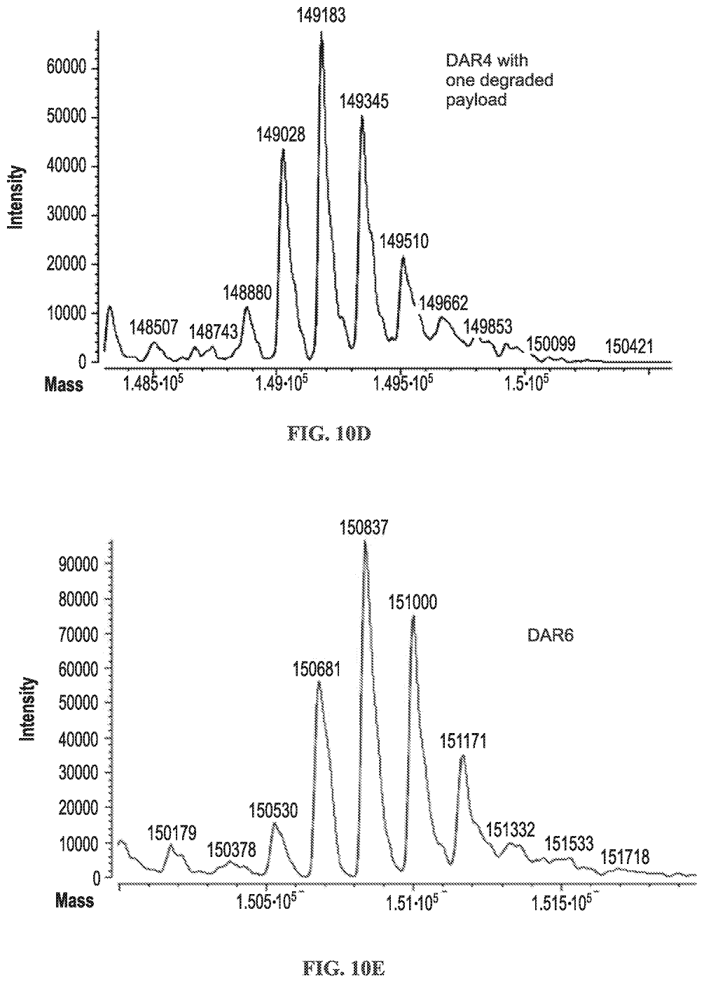

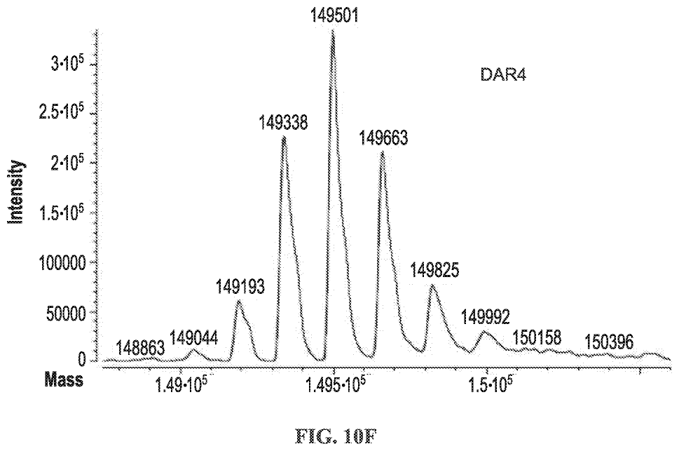

FIGS. 10A-10F show results obtained from the analysis of an ADC mimic using the prototype chromatography column V3 according to EXAMPLE 2. 10A: HRMS (top) and UV@280 nm (bottom) chromatograms. 10B-10F: Deconvoluted spectra for the various DAR species FIG. 11A-11C show the LC-HRMS XIC (XIC=extracted ion current) chromatograms from the analysis of the commercial ADC Polivy™ (polituzumab vedotin-piiq) using three different prototype columns, each with a different polymer composition. The prototype-2 (FIG. 11A), prototype-4 (FIG. 11B) and prototype-6 (FIG. 11C) columns have a bonded polymer composition of 50/50, 75/25 and 1/99 by weight of HEMA/MMA, respectively. This series of chromatograms demonstrates the polarity, and thus analyte retention, of the columns can be adjusted by varying the polymer composition. This control of bonded phase polarity allows tuning of the retention of the columns to match the hydrophilicity of the analyte allowing it to elute in its native, intact state with relatively low organic solvent in the mobile phase. The calculated drug to antibody ratio (DAR) value is shown along with the the XIC parameters and separation equipment and conditions.

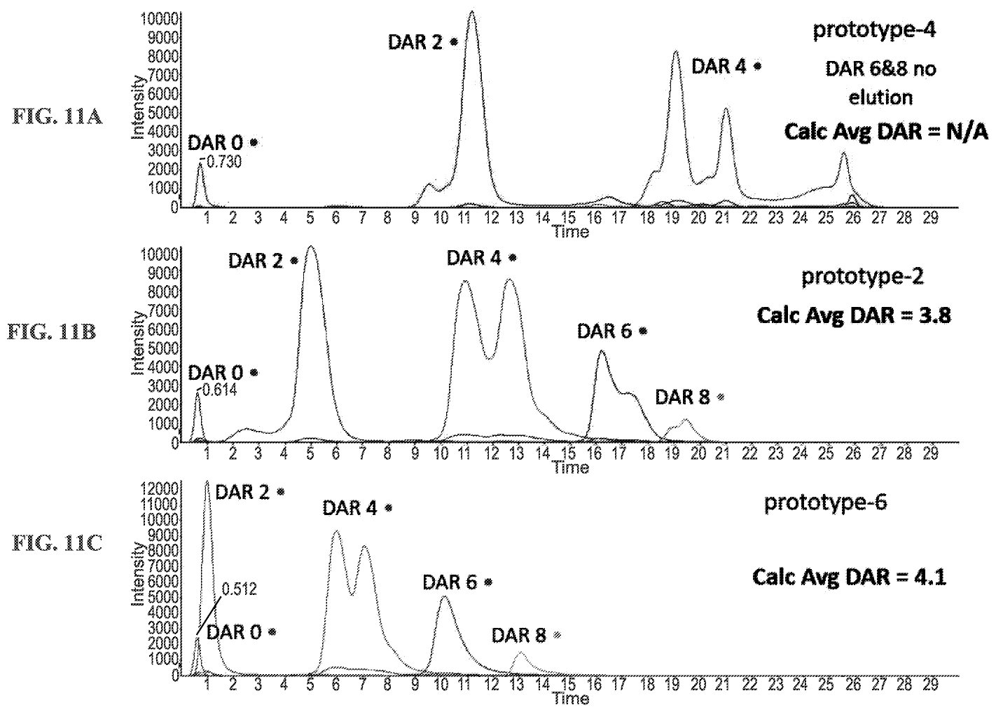

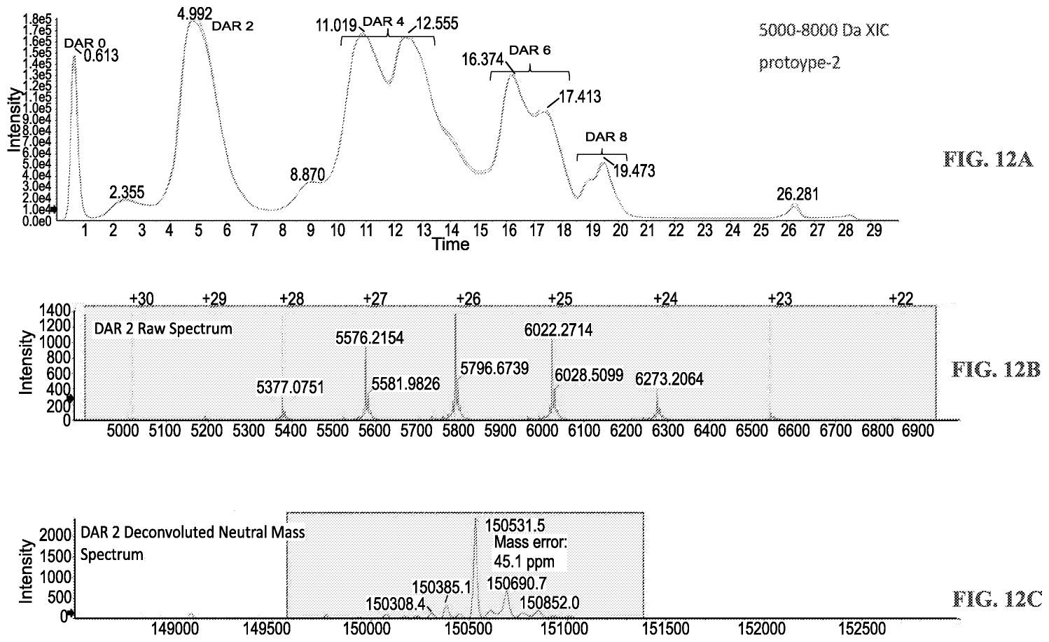

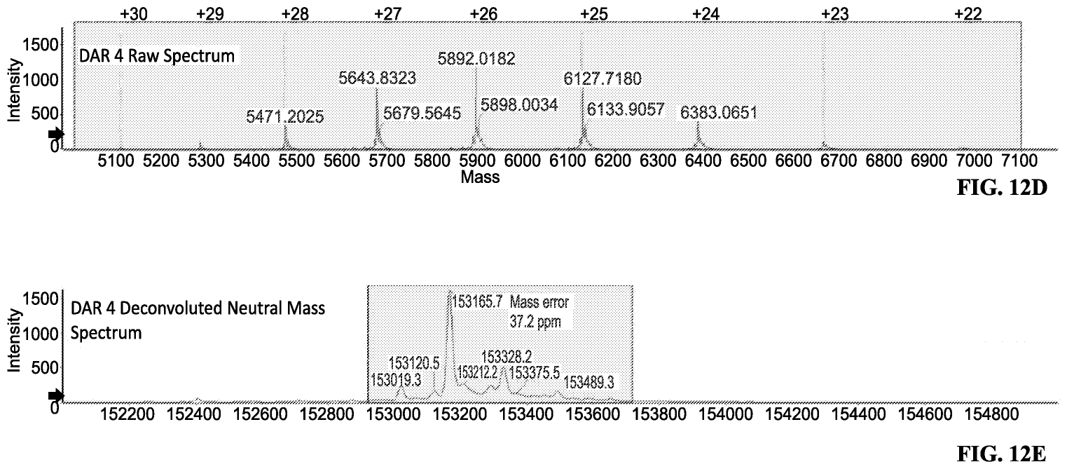

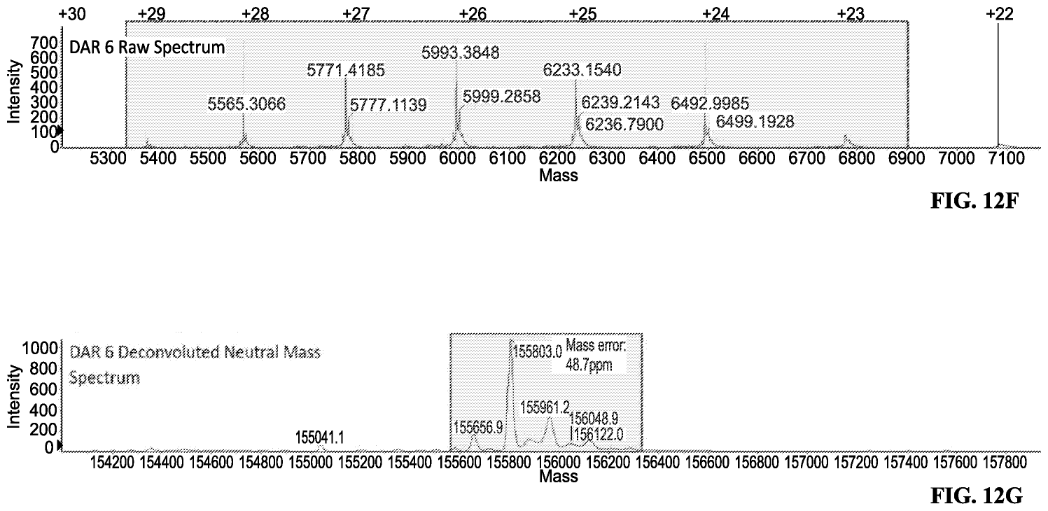

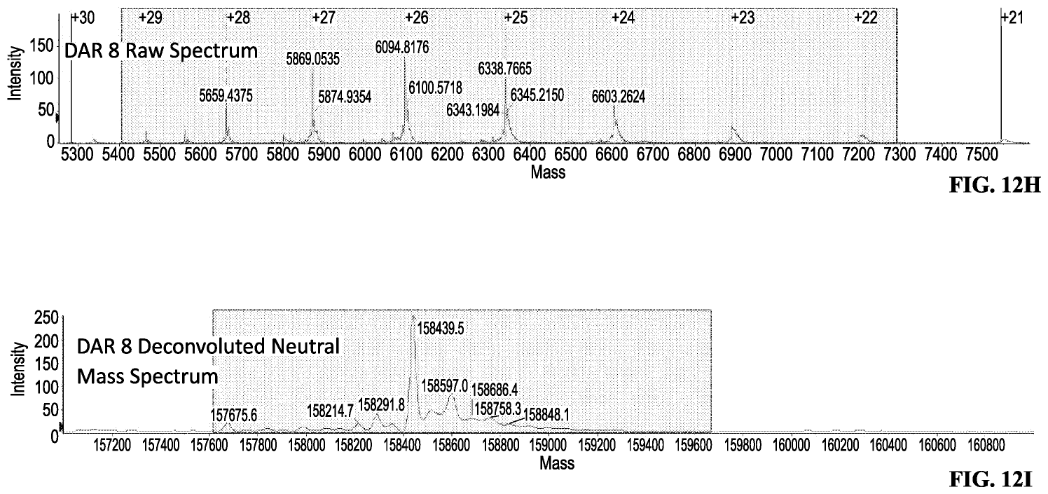

FIG. 12A-12I show detailed LC-HRMS results from analysis of the commercial ADC Polivy™ (polituzumab vedotin-piiq) on column Prototype-2 (50/50, by weight of HEMA/MMA). The XIC chromatogram from the native region (m/z 5000-8000) shows the retention time of all DAR species. The raw HRMS spectrum and the deconvoluted neutral mass spectrum for all DAR species are shown and demonstrate all elute in the native, intact state.

The present invention and embodiments herein are further exemplified and captured in the following clauses:

Clause 1. A chromatographic stationary phase, comprising:
a solid support; and
a polymer coating on a surface of the solid support;
   wherein the polymer coating comprises a copolymer comprising a first hydrophilic monomer and a second hydrophilic monomer, wherein the copolymer has a tuned hydrophilicity determined by a molar ratio of the first hydrophilic monomer and second hydrophilic monomer.

Clause 2. The chromatographic stationary phase of clause 1, wherein the first hydrophilic monomer and second hydrophilic monomer are different.

Clause 3. The chromatographic stationary phase of clause 1, wherein the second hydrophilic monomer has a lower hydrophilicity than the first hydrophilic monomer.

Clause 4. The chromatographic stationary phase of clause 1, wherein the solid support comprises a multi-capillary column, a monolith, a plurality of support particles, or any combinations thereof.

Clause 5. The chromatographic stationary phase of clause 1, wherein the solid support has a surface comprising a plurality of functional groups covalently attached thereto.

Clause 6. The chromatographic stationary phase of clause 5, wherein the functional group is selected from at least one of hydroxyl, silanol, amino, or any combinations thereof.

Clause 7. The chromatographic stationary phase of clause 5, wherein the copolymer is attached to the surface of the solid support via a linker/spacer that covalently connects the copolymer and at least one of the functional groups.

Clause 8. The chromatographic stationary phase of clause 1, wherein the solid support comprises a plurality of inorganic particles selected from at least one of: silica particle, alumina particle, titania particle, zirconia particle, iron oxide article, glass bead, or combinations thereof.

Clause 9. The chromatographic stationary phase of clause 1, wherein the support particles comprise a plurality of nonporous silicon dioxide particles having a diameter from about 0.5 μm to about 50 μm.

Clause 10. The chromatographic stationary phase of clause 1, wherein the first hydrophilic monomer comprises an ethylenically (—C═C) unsaturated group coupled to a hydrophilic functional group selected from polyethylene oxide, hydroxyl, dihydroxyl, multi-hydroxyl, carboxylic, sulfonic, phosphoric, amine, amide, or any combinations thereof.

Clause 11. The chromatographic stationary phase of clause 1, wherein the second hydrophilic monomer comprises an ethylenically unsaturated group coupled to a linear or branched, or cyclic (n>3) C1 to C18 saturated or unsaturated alkyl group, an aryl group, an aromatic group, a fluorocarbon group, or any combinations thereof.

Clause 12. The chromatographic stationary phase of clause 1, wherein the first hydrophilic monomer is selected from 2-hydroxyethyl (meth)acrylate, 3-hydroxypropyl (meth)acrylate, 2,3-dihybroxylpropyl (meth)acrylate, vinyl acetate, vinyl alcohol, sodium (meth)acrylate, tetrahydrofurfuryl (meth)acrylate, furfuryl (meth)acrylate, glycidyl (meth)acrylate, 2-(diethylamino)ethyl (meth)acrylate, 2-aminoethyl (meth)acrylate hydrochloride, 2-ethoxyethyl (meth)acrylate, 3-sulfopropyl (meth)acrylate potassium salt, glycosyloxyethyl (meth)acrylate, or derivatives thereof, or any combinations thereof.

Clause 13. The chromatographic stationary phase of clause 1, wherein the second hydrophilic monomer is selected from alkyl (meth)acrylate, (alkyl=Me, Et, n-Pr, i-Pr, n-Bu, s-Bu, t-Bu, etc.), hexyl (meth)acrylate, cyclohexyl (meth)acrylate, 2-ethylhexyl (meth)acrylate, lauryl (meth)acrylate, stearyl (meth)acrylate isodecyl (meth)acrylate, isobornyl (meth)acrylate, phenyl (meth)acrylate, 2-naphthyl (meth)acrylate, 9-anthracenylmethyl (meth)acrylate, 2,2,3,4,4,4-hexafluorobutyl (meth)acrylate, octadecyl (meth)acrylate, styrene, or derivatives thereof, or any combinations thereof.

Clause 14. The chromatographic stationary phase of clause 1, wherein the molar ratio of the first hydrophilic monomer to the second hydrophilic monomer ranges from about 1:100 to about 100:1,from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

Clause 15. The chromatographic stationary phase of clause 1, wherein the polymer coating comprises a copolymer of 2-hydroxyethyl methacrylate (HEMA) and methyl methacrylate (MMA), and wherein the molar ratio of HEMA to MMA is from 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

Clause 16. The chromatographic stationary phase of clause 1, wherein the polymer coating has a thickness from about 1 nm to about 500 nm.

Clause 17. The chromatographic stationary phase of clause 1, wherein the polymer coating is formed by grafting/growing the copolymer from a surface of the solid support.

Clause 18. The chromatographic stationary phase of clause 17, wherein the copolymer is grafted from the surface of the solid support via living/controlled radical copolymerization (L/CRP) of the first hydrophilic monomer and the second hydrophilic monomer.

Clause 19. The chromatographic stationary phase of clause 18, wherein the copolymer is grafted from the surface of the solid support via atom-transfer radical polymerization (ATRP) or, nitroxide-mediated radical polymerization (NMP), or reversible addition-fragmentation chain-transfer (RAFT).

Clause 20. The chromatographic stationary phase of clause 19, wherein the ATRP or AGET-ATRP is initiated by an initiator covalently attached to the surface of the solid support, and wherein the initiator comprises: (chloromethylphenylethyl)trimethoxysilane, 3-trimethoxysilyl propyl 2-bromo 2-methylpropionate, [11-(2-bromo-2-ethyl)propionyloxy]undecyltrichlorosilane or combinations thereof]).

Clause 21. The chromatographic stationary phase of clause 20, wherein the initiator is covalently attached to at least one functional group of the surface of the solid support, wherein the functional group is selected from hydroxyl, silanol, amino, or any combinations thereof.

Clause 22. A chromatographic column comprising the chromatographic stationary phase according to clause 1.

Clause 23. The chromatographic column of clause 22, wherein the chromatographic column has a length of 1 to 50 cm and an inner diameter of 25 μm to 10 cm.

Clause 24. The chromatographic column of clause 22, wherein the solid support comprises a plurality of support particles that are uniformly packed and exhibit no cracks or uninterrupted contact between the inner surface of the chromatographic column and the support particles.

Clause 25. The chromatographic column of clause 22, wherein the chromatographic column is suitable for HPLC, UHPLC, FPLC, SPE, LC-MS.

Clause 26. The chromatographic column of clause 22, wherein the chromatographic column is suitable for native hydrophobic interaction chromatography and native reverse phase chromatography of antibody-drug conjugates (ADCs).

Clause 27. A method for making a chromatography column, the method comprising:
providing a solid support for a chromatography column; and forming a polymer coating on a surface of the solid support,
wherein the polymer coating comprises a copolymer comprising a first hydrophilic monomer and a second hydrophilic monomer, wherein the copolymer has a tuned hydrophilicity determined by a molar ratio of the first hydrophilic monomer and second hydrophilic monomer.

Clause 28. The method of clause 27, wherein the first hydrophilic monomer and second hydrophilic monomer are different.

Clause 29. The method of clause 27, wherein the second hydrophilic monomer has a lower hydrophilicity than the first hydrophilic monomer.

Clause 30. The method of clause 27, wherein the solid support comprises a multi-capillary column, a monolith, a plurality of support particles, or any combinations thereof.

Clause 31. The method of clause 27, wherein the solid support has a surface comprising a plurality of functional groups attached thereto.

Clause 32. The method of clause 27, wherein the functional group is selected from at least one of hydroxyl, silanol, amino, or any combinations thereof.

Clause 33. The method of clause 27, wherein the solid support comprises a plurality of support particles, and wherein the method further comprises:
packing the chromatography column with the support particles; and forming a polymer coating on a surface of at least one support particle.

Clause 34. The method of clause 33, wherein forming the polymer coating comprises forming the copolymer covalently attached to the surface of the solid support via a linker/spacer that covalently connects the copolymer and the surface.

Clause 35. The method of clause 33, wherein the support particles comprise a plurality of inorganic particles selected from at least one of: silica particles, alumina particles, titania particles, zirconia particles, iron oxide particles, glass beads, or combinations thereof.

Clause 36. The method of clause 35, wherein the support particles comprise a plurality of nonporous silicon dioxide particles having a diameter from about 0.5 μm to about 50 μm.

Clause 37. The method of clause 27, wherein the first hydrophilic monomer comprises an ethylenically (—C═C) unsaturated group coupled to a hydrophilic functional group selected from polyethylene oxide, hydroxyl, dihydroxyl, multi-hydroxyl, carboxylic, sulfonic, phosphoric, amine, amide, or any combinations thereof.

Clause 38. The method of clause 27, wherein the second hydrophilic monomer comprises an ethylenically unsaturated group coupled to a linear or branched, or cyclic (n>3) C1 to C18 saturated or unsaturated alkyl group, an aryl group, an aromatic group, a fluorocarbon group, or any combinations thereof.

Clause 39. The method of clause 27, wherein the first hydrophilic monomer is selected from 2-hydroxyethyl (meth)acrylate, 3-hydroxypropyl (meth)acrylate, 2,3-dihybroxylpropyl (meth)acrylate, vinyl acetate, vinyl alcohol, sodium (meth)acrylate, tetrahydrofurfuryl (meth)acrylate, furfuryl (meth)acrylate, glycidyl (meth)acrylate, 2-(diethylamino)ethyl (meth)acrylate, 2-aminoethyl (meth)acrylate hydrochloride, 2-ethoxyethyl (meth)acrylate, 3-sulfopropyl (meth)acrylate potassium salt, glycosyloxyethyl (meth)acrylate, or derivatives thereof, or any combinations thereof.

Clause 40. The method of clause 27, wherein the second hydrophilic monomer is selected from alkyl (meth)acrylate, (alkyl=Me, Et, n-Pr, i-Pr, n-Bu, s-Bu, t-Bu, etc.), hexyl (meth)acrylate, cyclohexyl (meth)acrylate, 2-ethylhexyl (meth)acrylate, lauryl (meth)acrylate, stearyl (meth)acrylate isodecyl (meth)acrylate, isobornyl (meth)acrylate, phenyl (meth)acrylate, 2-naphthyl (meth)acrylate, 9-anthracenylmethyl (meth)acrylate, 2,2,3,4,4,4-hexafluorobutyl (meth)acrylate, octadecyl (meth)acrylate, styrene, or derivatives thereof, or any combinations thereof.

Clause 41. The method of clause 27, wherein the polymer coating comprises a copolymer of 2-hydroxyethyl methacrylate (HEMA) and methyl methacrylate (MMA), and wherein the molar ratio of HEMA to MMA is from 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

Clause 42. The method of clause 27, wherein the polymer coating has a thickness from about 1 nm to about 500 nm.

Clause 43. The method of clause 27, wherein forming the polymer coating comprises grafting/growing the copolymer from the surface of the support particle via living/controlled polymerization (L/CRP) of the hydrophilic and second hydrophilic monomers using an initiator covalently attached to the surface of the support particle.

Clause 44. The method of clause 43, wherein the copolymer is grafted from the surface of the support particle via atom-transfer radical polymerization (ATRP) or activator regeneration ATRP, nitroxide-mediated radical polymerization (NMP), or reversible addition-fragmentation chain-transfer (RAFT).

Clause 45. The method of clause 44, further comprising covalently attaching an initiator or an initiating group/site onto the surface of the solid particle prior to copolymerization, wherein the initiator is used the initiate the formation of the polymer coating on the support particles.

Clause 46. The method of clause 45, wherein the initiator comprises: (chloromethylphenylethyl)trimethoxysilane, 3-trimethoxysilyl propyl 2-bromo 2-methylpropionate, [11-(2-bromo-2-ethyl)propionyloxy]undecyltrichlorosilane or combinations thereof.

Clause 47. The method of clause 45, wherein the initiator is covalently attached to at least one functional group of the surface of the solid support, wherein the functional group is selected from hydroxyl, silanol, amino, or any combinations thereof.

Clause 48. The method of clause 27, wherein the chromatography column is packed after forming the polymer coating.

Clause 49. The method of clause 27, wherein the chromatography column is packed before forming the polymer coating to form packed support particles, and wherein forming the polymer coating comprises grafting/growing the copolymer on a surface of at least one of the packed support particles.

Clause 50. The method of clause 27, further comprising introducing a monomer or a pre-polymer solution to the packed support particles.

Clause 51. The method of clause 27, wherein the polymer coating has a substantially uniform density throughout the support particles.

Clause 52. A chromatography column prepared by the method of clause 27.

Clause 53. A method for making a chromatography column, the method comprising: providing a solid support comprising a plurality of support particles; forming a polymer coating on a surface of at least one of the support particles; and packing the chromatography column with the support particles,

wherein the polymer coating comprises a copolymer of 2-hydroxyethyl methacrylate (HEMA) and methyl methacrylate (MMA), wherein the copolymer has a tuned hydrophilicity determined by a molar ratio of HEMA to MMA in a range from about 1:100 to about 100:1.

Clause 54. The method of clause 52, further comprising:
attaching an initiator covalently onto the surface of the solid particle;
grafting/growing the copolymer from the surface via living/controlled radical copolymerization (L/CRP) of HEMA and MMA using the initiator.

Clause 55. A method for analyzing antibody-drug conjugates (ADCs) in a sample, the method comprising:
(a) exposing the sample to a chromatographic stationary phase of a reverse phase chromatography column, the chromatographic stationary phase comprising:
a solid support; and
a polymer coating on a surface of the solid support;
wherein the polymer coating comprises a copolymer comprising a first hydrophilic monomer and a second hydrophilic monomer, wherein the copolymer has a tuned hydrophilicity determined by a molar ratio of the first hydrophilic monomer and second hydrophilic monomer;
(b) applying an eluent to the chromatography column to elute the antibody-drug conjugates in their native, intact form.

Clause 56. The method of clause 55, wherein the solid support comprise a plurality of support particles having a diameter from about 0.5 μm to about 50 μm.

Clause 57. The method of clause 55, wherein the first hydrophilic monomer comprises an ethylenically (—C═C) unsaturated group coupled to a hydrophilic functional group selected from polyethylene oxide, hydroxyl, dihydroxyl, multi-hydroxyl, carboxylic, sulfonic, phosphoric, amine, amide, or any combinations thereof.

Clause 58. The method of clause 55, wherein the second hydrophilic monomer comprises an ethylenically unsaturated group coupled to a linear or branched, or cyclic (n>3) C1 to C18 saturated or unsaturated alkyl group, an aryl group, an aromatic group, a fluorocarbon group, or any combinations thereof.

Clause 59. The method of clause 55, wherein the molar ratio of the first hydrophilic monomer to the second hydrophilic monomer ranges from about 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

Clause 60. The method of clause 55, wherein the polymer coating comprises a copolymer of 2-hydroxyethyl methacrylate (HEMA) and methyl methacrylate (MMA), and wherein the molar ratio of HEMA to MMA is from 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

Clause 61. The method of clause 55, wherein the polymer coating is formed by grafting/growing the copolymer from a surface of the solid support.

Clause 62. The method of clause 55, wherein the copolymer is grafted from the surface via living/controlled radical copolymerization (L/CRP) of the first hydrophilic monomer and the second hydrophilic monomer.

Clause 63. The method of clause 55, further comprising separating and resolving eluted DAR species of an ADC in their native form.

Clause 64. The method of clause 55, wherein the eluted DAR species of the ADC have the same or different drug to antibody ratio (DAR).

Clause 65. The method of clause 55, further comprising detecting the eluted DAR species in an ADCs in their native, intact form using mass spectrometry.

Clause 66. The method of clause 55, wherein the mass spectrometry is used to establish a mass-to-charge (m/z) ratio or molecular mass and a DAR value for at least one of the eluted ADC across various DAR ratios.

Clause 67. The method of clause 55, wherein the method is used to determine the relative quantity of each eluted DAR species in an ADC sample.

Clause 68. The method of clause 55, wherein the method is used to separate positional isomers of the DAR species in an ADC having the same DAR value.

Clause 69. The method of clause 55, the eluent has a salt concentration no more than about 100 mM.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

1. A chromatographic stationary phase, comprising:
a solid support; and
a polymer coating on a surface of the solid support;
wherein the polymer coating comprises a copolymer comprising a first hydrophilic monomer and a second hydrophilic monomer, wherein the copolymer has a tuned hydrophilicity determined by a molar ratio of the first hydrophilic monomer and the second hydrophilic monomer.

2. The chromatographic stationary phase of claim 1, wherein the first hydrophilic monomer and the second hydrophilic monomer are different.

3. The chromatographic stationary phase of claim 1, wherein the second hydrophilic monomer has a lower hydrophilicity than the first hydrophilic monomer.

4. The chromatographic stationary phase of claim 1, wherein the solid support comprises a multi-capillary column, a monolith, a plurality of support particles, or any combinations thereof.

5. The chromatographic stationary phase of claim 4, wherein the support particles comprise a plurality of nonporous silicon dioxide particles having a diameter from about 0.5 μm to about 50 μm.

6. The chromatographic stationary phase of claim 1, wherein the first hydrophilic monomer comprises an ethylenically (—C═C) unsaturated group coupled to a hydrophilic functional group selected from polyethylene oxide, hydroxyl, dihydroxyl, multi-hydroxyl, carboxylic, sulfonic, phosphoric, amine, amide, or any combinations thereof.

7. The chromatographic stationary phase of claim 1, wherein the second hydrophilic monomer comprises an ethylenically unsaturated group coupled to a linear or branched, or cyclic (n>3) C1 to C18 saturated or unsaturated alkyl group, an aryl group, an aromatic group, a fluorocarbon group, or any combinations thereof.

8. The chromatographic stationary phase of claim 1, wherein the first hydrophilic monomer is selected from 2-hydroxyethyl (meth)acrylate, 3-hydroxypropyl (meth)acrylate, 2,3-dihybroxylpropyl (meth)acrylate, vinyl acetate, vinyl alcohol, sodium (meth)acrylate, tetrahydrofurfuryl (meth)acrylate, furfuryl (meth)acrylate, glycidyl (meth)acrylate, 2-(diethylamino)ethyl (meth)acrylate, 2-aminoethyl (meth)acrylate hydrochloride, 2-ethoxyethyl (meth)acrylate, 3-sulfopropyl (meth)acrylate potassium salt, glycosyloxyethyl (meth)acrylate, or derivatives thereof, or any combinations thereof.

9. The chromatographic stationary phase of claim 1, wherein the second hydrophilic monomer is selected from alkyl (meth)acrylate, (alkyl=Me, Et, n-Pr, i-Pr, n-Bu, s-Bu, t-Bu, etc.), hexyl (meth)acrylate, cyclohexyl (meth)acrylate, 2-ethylhexyl (meth)acrylate, lauryl (meth)acrylate, stearyl (meth)acrylate isodecyl (meth)acrylate, isobornyl (meth)acrylate, phenyl (meth)acrylate, 2-naphthyl (meth)acrylate, 9-anthracenylmethyl (meth)acrylate, 2,2,3,4,4,4-hexafluorobutyl (meth)acrylate, octadecyl (meth)acrylate, styrene, or derivatives thereof, or any combinations thereof.

10. The chromatographic stationary phase of claim 1, wherein the polymer coating comprises a copolymer of 2-hydroxyethyl methacrylate (HEMA) and methyl methacrylate (MMA), and wherein the molar ratio of HEMA to MMA is from 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

11. The chromatographic stationary phase of claim 1, wherein the polymer coating has a thickness from about 1 nm to about 500 nm.

12. The chromatographic stationary phase of claim 1, wherein the copolymer is grafted from the surface of the solid support via atom-transfer radical polymerization (ATRP), or, nitroxide-mediated radical polymerization (NMP), or reversible addition-fragmentation chain-transfer (RAFT).

13. A chromatographic column comprising the chromatographic stationary phase according to claim 1.

14. A method for analyzing antibody-drug conjugates (ADCs) in a sample, the method comprising:
(a) exposing the sample to a chromatographic stationary phase of a reverse phase chromatography column, the chromatographic stationary phase comprising:
a solid support; and
a polymer coating on a surface of the solid support;
wherein the polymer coating comprises a copolymer comprising a first hydrophilic monomer and a second hydrophilic monomer, wherein the copolymer has a tuned hydrophilicity determined by a molar ratio of the first hydrophilic monomer and the second hydrophilic monomer; and
(b) applying an eluent to the chromatography column to elute the antibody-drug conjugates in their native, intact form.

15. The method of claim 14, wherein the polymer coating comprises a copolymer of 2-hydroxyethyl methacrylate (HEMA) and methyl methacrylate (MMA), and wherein the molar ratio of HEMA to MMA is from 1:100 to about 100:1, from about 1:50 to about 50:1, from about 1:25 to about 25:1, from 1:10 to about 10:1, from about 1:5 to about 5:1, or from about 1:2 to about 2:1, from about 1:1.5 to about 1.5:1, from about 1:1.2 to about 1.2:1, from about 1.1:1 to about 1:1.1, or about 1:1.

16. The method of claim 14, further comprising separating and resolving eluted DAR species of an ADC in their native form.

17. The method of claim 14, wherein the method is used to separate positional isomers of DAR species in an ADC having a same DAR value.
